(19) United States
(12) Patent Application Publication
(10) Pub. No.: US 2004/0187038 A1
(43) Pub. Date: Sep. 23, 2004

(54) Electronic equipment, equipment managing apparatus, equipment maintenance system, equipment maintenance method and computer-readable storage medium

(76) Inventor: Masuyoshi Yachida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/803,955

(22) Filed: Mar. 19, 2004

(30) Foreign Application Priority Data
Mar. 20, 2003 (JP) 2003-077822
Mar. 3, 2004 (JP) 2004-059559

(51) Int. Cl. H04L 9/32

(52) U.S. Cl. 713/202

(57) ABSTRACT

An electronic equipment has parts which may be subjected to maintenance and are specified by a maintenance range. The electronic equipment includes a setting part which is set with a predetermined maintenance range in which the maintenance is permitted, an authenticating part to authenticate validity of a maintenance-attending person for the electronic equipment, and a changing part to temporarily change the predetermined maintenance range set in the setting part, in response to a change instruction, when the authenticating part authenticates the validity of the maintenance-attending person.

### BACKGROUND OF THE INVENTION

This application claims the benefit of a Japanese Patent Applications No.2003-077822 filed Mar. 20, 2003 and No.2004-059559 filed Mar. 3, 2004, in the Japanese Patent Office, the disclosures of which are hereby incorporated by reference.

1. Field of the Invention

The present invention generally relates to electronic equipments, equipment managing apparatuses, equipment maintenance systems, equipment maintenance methods and computer-readable storage media, and more particularly to an electronic equipment which may require maintenance and is set with a maintenance range, an equipment managing apparatus, an equipment maintenance system, an equipment maintenance method and a computer-readable storage medium which are suited for managing the maintenance of such an electronic equipment.

In this specification, the electronic equipment refers to an equipment or an apparatus which may require maintenance. The electronic equipment thus includes information processing apparatuses (hereinafter referred to as information equipments) including servers, general-purpose computers and personal computers; office automation equipments (OA equipments) including copying apparatuses, facsimile apparatuses, printing apparatuses and composite apparatuses; point-of-sales terminal equipments (POS terminal equipments); medical equipments; vending machines; electrical home appliances; and portable terminal equipments including portable telephones.

2. Description of the Related Art

Recently, work related to company activities, and particularly various work in offices, are carried out electronically. In addition, the work is not limited to the bounds of an in-house network of the company such as a local area network (LAN), and is efficiently carried out by utilizing external networks outside the company, such as the Internet. As a result, the work related to the company activities is greatly dependent on information systems, and it is extremely important that electronic equipments such as personal computers which form each information system operate correctly and are managed correctly.

Generally, as methods of performing maintenance of the electronic equipment, there is the method which sends a person (maintenance person) from a maintenance company which provides maintenance services, and the method which performs the so-called remote maintenance from a remote location via a telephone line or a network. Recently, the remote-maintenance is rapidly becoming popular because it can provide quick services.

Basically, two kinds of information may be stored within the electronic equipment, namely, a first kind of information and a second kind of information.

The first kind of information relates to the general management and maintenance of the equipment, such as an inspection to determine whether or not the equipment itself operates correctly, an accounting depending on a number of times the equipment is used, and an addition or updating of a software operating in the equipment. This first kind of information is the responsibility of a company which provided the equipment or a company which performs the maintenance of the equipment, and is managed by such companies, and not by a user who uses the equipment. Particular examples of the first kind of information include information indicating a state where a failure is generated in the equipment, an additional software which adds new functions to the equipment, and a recovery software which performs a recovery to solve problems generated in the equipment.

On the other hand, the second kind of information is dependent on the user who uses the equipment in an organization or company environment in which the equipment is set up, and is related to information such as information generated by use of each information system, and management information which is set to manage security. Particular examples of the second kind of information include documents and information that are created, security information for making a security setting with respect to the equipment, and user information.

The first and second kind of information are important from the point of view of managing the equipment itself and managing the user security, and must be safely treated. The second kind of information in particular, such as the information managed by the user and the information related to the general work, must not leak outside the organization or company environment of the user, and must be prevented from leaking to the company which provided the equipment or to the company which performs the maintenance of the equipment.

In other words, the second kind of information such as the user information may include confidential or secret information. For this reason, it is necessary to enable appropriate maintenance of the equipment by the maintenance person while preventing illegal access to the second kind of information.

An equipment authentication and enciphered communication system for securing safety of remote end terminals managed by a managing center, has been proposed in a Japanese Laid-Open Patent Application No.11-313056. According to this proposed system, information does not need to be transferred among the terminals because the terminals do not need to link to one another, and it is unnecessary to secure safety among the terminal.

On the other hand, various proposals have been made on techniques related to functions of the equipment set by the user and techniques related to equipment management such as remote-diagnosis. A remote maintenance system and a remote maintenance equipment which can perform appropriate maintenance without having to go to a site where the equipment to be managed is set up, has been proposed in a Japanese Laid-Open Patent Application No.2000-132364.

In addition, with regard to authentication of the equipment, a method of communicating via a low-reliability channel has been proposed in a Japanese Laid-Open Patent Application No.2001-148697, and a communication processing method for positively approving no-connection communication and maintaining secrecy has been proposed in a Japanese Laid-Open Patent Application No.10-145610.

Furthermore, a medical image diagnosis apparatus for controlling access right to services provided by the equipment by user authentication, a security managing method therefor and a maintenance managing method therefor have been proposed in a Japanese Laid-Open Patent Application No.2001-344349.

Conventionally, the user signs a contract with a maintenance company or the like who performs the maintenance of the equipment, and determines in advance the kind of maintenance to be performed depending on the user environment and the like. Accordingly, with regard to a predetermined portion of the equipment, which falls outside a maintenance range specified by the contract, it is possible to prevent even the maintenance person from making access thereto. As a result, it is possible to prevent the maintenance person from making an illegal access to the predetermined portion of the equipment. However, in a case where it is essential to make access to the predetermined portion of the equipment in order to eliminate the failure or fault of the equipment, there was a problem in that an appropriate maintenance cannot be performed.

On the other hand, if an extremely large maintenance range is set or the maintenance range is not restricted, the maintenance person can make access to virtually all portions or to all portions of the equipment. As a result, it is possible to positively and quickly eliminate the failure or fault in the equipment. However, since the maintenance person can make access to virtually all portions or to all portions of the equipment, there was a problem in that the security becomes poor. In other words, there was a problem in that it is impossible to positively prevent a third person from impersonating the maintenance person and illegally accessing the portions of the equipment.

Therefore, there is a tradeoff relationship between the positive and quick maintenance and the security improvement (prevention of illegal access), and there was a problem in that it is impossible to realize both simultaneously.

### SUMMARY OF THE INVENTION

Accordingly, it is a general object of the present invention to provide a novel and useful electronic equipment, equipment managing apparatus, equipment maintenance system, equipment maintenance method and computer-readable storage medium, in which the problems described above are eliminated.

Another and more specific object of the present invention is to provide an electronic equipment, an equipment managing apparatus, an equipment maintenance system, an equipment maintenance method and a computer-readable storage medium, which can not only authenticate an equipment maintenance person and an equipment manager (or operator), but also change a maintenance range and/or a management range of the electronic equipment, so that the maintenance is positively and quickly performed while at the same time improving the security.

Still another and more specific object of the present invention is to provide an electronic equipment having parts which may be subjected to maintenance and are specified by a maintenance range, comprising a setting part which is set with a predetermined maintenance range in which the maintenance is permitted; an authenticating part to authenticate validity of a maintenance-attending person for the electronic equipment; and a changing part to temporarily change the predetermined maintenance range set in the setting part, in response to a change instruction, when the authenticating part authenticates the validity of the maintenance-attending person. According to the electronic equipment of the present invention, it is possible to authenticate the equipment maintenance person and the equipment manager (or operator), and also change the maintenance range of the electronic equipment, so that the maintenance is positively and quickly performed while at the same time improving the security.

A further object of the present invention is to provide an equipment managing apparatus for controlling an electronic equipment which includes a setting part which is set with a predetermined maintenance range in which maintenance is permitted, a first authenticating part to authenticate validity of a maintenance-attending person for the electronic equipment, and a changing part to temporarily change the predetermined maintenance range set in the setting part in response to a change instruction when the first authenticating part authenticates the validity of the maintenance-attending person, the equipment managing apparatus comprising a second authenticating part to authenticate validity of an operator of the equipment managing apparatus; an input part to permit input of the change instruction when the second authenticating part authenticates the validity of the operator; and a part to supply the change instruction input from the input part to the electronic equipment. According to the equipment managing apparatus of the present invention, it is possible to authenticate the equipment maintenance person and the equipment manager (or operator), and also change the maintenance range of the electronic equipment, so that the maintenance is positively and quickly performed while at the same time improving the security.

Another object of the present invention is to provide an equipment maintenance system for controlling a maintenance range in which maintenance of an equipment may be performed, comprising a setting part to set in advance a maintenance range in which the maintenance of the equipment is permitted; a first authenticating part to authenticate validity of a maintenance-attending person for the equipment; and a changing part to temporarily change the set maintenance range to a predetermined maintenance range based on an authentication result of the first authenticating part, so that the maintenance of the equipment is temporarily permitted within the predetermined maintenance range. According to the equipment maintenance system of the present invention, it is possible to authenticate the equipment maintenance person and the equipment manager (or operator), and also change the maintenance range of the electronic equipment, so that the maintenance is positively and quickly performed while at the same time improving the security.

Still another object of the present invention is to provide an equipment maintenance method for controlling a maintenance range in which maintenance of an equipment may be performed, comprising the steps of (a) setting in advance a maintenance range in which the maintenance of the equipment is permitted; (b) authenticating validity of a maintenance-attending person for the equipment; and (c) temporarily changing the set maintenance range to a predetermined maintenance range based on an authentication result of the step (b), so that the maintenance of the equipment is temporarily permitted within the predetermined maintenance range. According to the equipment maintenance method of the present invention, it is possible to authenticate the equipment maintenance person and the equipment manager (or operator), and also change the maintenance range of the electronic equipment, so that the maintenance is positively and quickly performed while at the same time improving the security.

A further object of the present invention is to provide an electronic equipment having parts which may be subjected to maintenance and are specified by a maintenance range, comprising setting means set with a predetermined maintenance range in which the maintenance is permitted; authenticating means for authenticating validity of a maintenance-attending person for the electronic equipment; and changing means for temporarily changing the predetermined maintenance range set in the setting means, in response to a change instruction, when the authenticating means authenticates the validity of the maintenance-attending person. According to the electronic equipment of the present invention, it is possible to authenticate the equipment maintenance person and the equipment manager (or operator), and also change the maintenance range of the electronic equipment, so that the maintenance is positively and quickly performed while at the same time improving the security.

Another object of the present invention is to provide an equipment managing apparatus for controlling an electronic equipment which includes setting means set with a predetermined maintenance range in which maintenance is permitted, first authenticating means for authenticating validity of a maintenance-attending person for the electronic equipment, and changing means for temporarily changing the predetermined maintenance range set in the setting part in response to a change instruction when the first authenticating means authenticates the validity of the maintenance-attending person, the equipment managing apparatus comprising second authenticating means for authenticating validity of an operator of the equipment managing apparatus; input means for permitting input of the change instruction when the second authenticating means authenticates the validity of the operator; and means for supplying the change instruction input from the input means to the electronic equipment. According to the equipment managing apparatus of the present invention, it is possible to authenticate the equipment maintenance person and the equipment manager (or operator), and also change the maintenance range of the electronic equipment, so that the maintenance is positively and quickly performed while at the same time improving the security.

Still another object of the present invention is to provide an equipment maintenance system for controlling a maintenance range in which maintenance of an equipment may be performed, comprising setting means for setting in advance a maintenance range in which the maintenance of the equipment is permitted; authenticating means for authenticating validity of a maintenance-attending person for the equipment; and changing means for temporarily changing the set maintenance range to a predetermined maintenance range based on an authentication result of the authenticating means, so that the maintenance of the equipment is temporarily permitted within the predetermined maintenance range. According to the equipment maintenance system of the present invention, it is possible to authenticate the equipment maintenance person and the equipment manager (or operator), and also change the maintenance range of the electronic equipment, so that the maintenance is positively and quickly performed while at the same time improving the security.

A further object of the present invention is to provide a computer-readable storage medium which stores a program for causing a computer to set a maintenance range which specifies parts of an electronic equipment which may be subjected to maintenance, the program comprising a setting procedure causing the computer to be set with a predetermined maintenance range in which the maintenance is permitted; an authenticating procedure causing the computer to authenticate validity of a maintenance-attending person for the electronic equipment; and a changing procedure causing the computer to temporarily change the predetermined maintenance range set in the setting procedure, in response to a change instruction, when the authenticating procedure authenticates the validity of the maintenance-attending person. According to the computer-readable storage medium of the present invention, it is possible to authenticate the equipment maintenance person and the equipment manager (or operator), and also change the maintenance range of the electronic equipment, so that the maintenance is positively and quickly performed while at the same time improving the security.

Another object of the present invention is to provide a computer-readable storage medium which stores a program for causing a computer to manage an electronic equipment which includes a setting part set with a predetermined maintenance range in which maintenance is permitted, an authenticating part to authenticate validity of a maintenance-attending person for the electronic equipment, and a changing part to temporarily change the predetermined maintenance range set in the setting part in response to a change instruction when the authenticating part authenticates the validity of the maintenance-attending person, the program comprising an authenticating procedure causing the computer to authenticate validity of an operator of the computer; an input procedure causing the computer to permit input of the change instruction when the authenticating procedure authenticates the validity of the operator; and a procedure causing the computer to supply the change instruction input by the input procedure to the electronic equipment. According to the computer-readable storage medium of the present invention, it is possible to authenticate the equipment maintenance person and the equipment manager (or operator), and also change the maintenance range of the electronic equipment, so that the maintenance is positively and quickly performed while at the same time improving the security.

Still another object of the present invention is to provide a computer-readable storage medium which stores a program for causing a computer to control a maintenance range in which maintenance of an equipment may be performed, the program comprising a setting procedure causing the computer to set in advance a maintenance range in which the maintenance of the equipment is permitted; an authenticating procedure causing the computer to authenticate validity of a maintenance-attending person for the equipment; and a changing procedure causing the computer to temporarily change the set maintenance range to a predetermined maintenance range based on an authentication result of the authenticating procedure, so that the maintenance of the equipment is temporarily permitted within the predetermined maintenance range. According to the computer-readable storage medium of the present invention, it is possible to authenticate the equipment maintenance person and the equipment manager (or operator), and also change the maintenance range of the electronic equipment, so that the maintenance is positively and quickly performed while at the same time improving the security.

Other objects and further features of the present invention will be apparent from the following detailed description when read in conjunction with the accompanying drawings.

### BRIEF DESCRIPTION OF THE DRAWINGS

FIG. 1 is a diagram showing a structure of an electronic equipment for explaining a first embodiment of the electronic equipment, an equipment managing apparatus, an equipment maintenance system, an equipment maintenance method and a computer-readable storage medium according to the present invention;

FIG. 2 is a flow chart for explaining a maintenance sequence for the electronic equipment in the first embodiment;

FIG. 3 is a diagram for explaining setting of authentication information and maintenance range information in the first embodiment;

FIG. 4 is a diagram showing a structure of the electronic equipment for explaining a second embodiment of the electronic equipment, the equipment managing apparatus, the equipment maintenance system, the equipment maintenance method and the computer-readable storage medium according to the present invention;

FIG. 5 is a diagram showing a structure of the electronic equipment for explaining a third embodiment of the electronic equipment, the equipment managing apparatus, the equipment maintenance system, the equipment maintenance method and the computer-readable storage medium according to the present invention;

FIG. 6 is a diagram for explaining the setting of the authentication information and additional maintenance range information in the third embodiment;

FIG. 7 is a system block diagram showing a structure of the equipment maintenance system for explaining a fourth embodiment of the electronic equipment, the equipment managing apparatus, the equipment maintenance system, the equipment maintenance method and the computer-readable storage medium according to the present invention;

FIG. 8 is a diagram showing a structure of the electronic equipment for explaining the fourth embodiment of the electronic equipment, the equipment managing apparatus, the equipment maintenance system, the equipment maintenance method and the computer-readable storage medium according to the present invention;

FIG. 9 is a diagram for explaining the setting of the authentication information and the maintenance range information in the fourth embodiment;

FIG. 10 is a system block diagram showing a system which may be applied with the first embodiment;

FIG. 11 is a flow chart for explaining an embodiment of a maintenance range setting procedure;

FIG. 12 is a diagram showing a maintenance person registration screen displayed on a display part;

FIG. 13 is a flow chart for explaining an embodiment of a maintenance procedure;

FIG. 14 is a diagram showing a maintenance work input screen;

FIG. 15 is a flow chart for explaining another embodiment of the maintenance procedure;

FIG. 16 is a flow chart for explaining another embodiment of the maintenance procedure;

FIG. 17 is a flow chart for explaining another embodiment of the maintenance procedure;

FIG. 18 is a flow chart for explaining another embodiment of the maintenance procedure;

FIG. 19 is a flow chart for explaining an embodiment of a maintenance range changing procedure;

FIG. 20 is a diagram showing a maintenance range changing screen displayed on the display part;

FIG. 21 is a flow chart for explaining another embodiment of the maintenance range changing procedure;

FIG. 22 is a diagram showing a maintenance range changing screen displayed on the display part;

FIG. 23 is a flow chart for explaining an embodiment of a maintenance range adding procedure;

FIG. 24 is a diagram showing a maintenance range adding screen displayed on the display part;

FIG. 25 is a flow chart for explaining an embodiment of the maintenance procedure after adding the maintenance range;

FIG. 26 is a system block diagram showing a system which enables changing of the maintenance range by issuing a maintenance permit;

FIG. 27 is a flow chart for explaining an embodiment of a maintenance permit issuing procedure;

FIG. 28 is a flow chart for explaining an embodiment of the maintenance procedure using the maintenance permit;

FIG. 29 is a system block diagram showing a system which may be applied with the present invention when changing the maintenance range by issuing the maintenance permit;

FIG. 30 is a flow chart for explaining another embodiment of the maintenance permit issuing procedure;

FIG. 31 is a flow chart for explaining an embodiment of a maintenance permit issuing procedure for issuing a maintenance permit for remote maintenance;

FIG. 32 is a flow chart for explaining a portion of an embodiment of the maintenance procedure using the maintenance permit for remote maintenance;

FIG. 33 is a flow chart for explaining a remaining portion of the embodiment of the maintenance procedure using the maintenance permit for remote maintenance;

FIG. 34 is a diagram showing a maintenance work input screen;

FIG. 35 is a flow chart for explaining another embodiment of the maintenance permit issuing procedure for issuing the maintenance permit for remote maintenance;

FIG. 36 is a flow chart for explaining an embodiment of a mutual authentication procedure between equipments; and

FIG. 37 is a flow chart for explaining another embodiment of the mutual authentication procedure between equipments.

### DESCRIPTION OF THE PREFERRED EMBODIMENTS

As described above, an object of the present invention is to provide an electronic equipment, an equipment managing apparatus, an equipment maintenance system, an equipment maintenance method and a computer-readable storage medium, which can not only authenticate a maintenance person and a manager (or operator), but also change a maintenance range and/or a management range of the electronic equipment, so that the maintenance is positively and quickly performed while at the same time improving the security.

In order to achieve this object, the present inventor studied authenticating the equipment maintenance person and the equipment manager (or operator) and also variably setting the maintenance range and/or the management range of the electronic equipment, so as to simultaneously realize positive and quick maintenance of the equipment and the improved security.

In other words, the electronic equipment, the equipment managing apparatus, the equipment maintenance system, the equipment maintenance method and the computer-readable storage medium according to the present invention have the following characterizing features.

An electronic equipment having parts which may be subjected to maintenance and are specified by a maintenance range, comprises a setting part or means which is set with a predetermined maintenance range in which the maintenance is permitted, an authenticating part or means to authenticate validity of a maintenance-attending person for the electronic equipment, and a changing part or means to temporarily change the predetermined maintenance range set in the setting part or means, in response to a change instruction, when the authenticating part or means authenticates the validity of the maintenance-attending person. The maintenance range may be set by a maintenance service provider or an equipment manager on the side of a user who uses the electronic equipment. In addition, by providing the changing part or means to temporarily changing the maintenance range, it is possible to temporarily enable maintenance exceeding the predetermined maintenance range which is set in advance. The maintenance range may be changed by the maintenance service provider or the equipment manager. In addition, the maintenance service provider or the equipment manager may temporarily change the maintenance range. Accordingly, by adding a specific maintenance range to the normal maintenance range, it is possible to temporarily enable maintenance which exceeds the normal maintenance range.

The maintenance-attending person refers to the person who attends or is to attend to the maintenance of the electronic equipment, and may not necessarily be the maintenance person who is authorized to attend to the maintenance of the electronic equipment. In other words, the maintenance-attending person is the maintenance person when authenticated, but may be a third person who is unauthorized to perform the maintenance or is impersonating the maintenance person when unable to be authenticated.

A program for causing a computer to realize the above described functions may be installed in an equipment managing apparatus and/or the electronic equipment, and the program may be stored in the computer-readable storage medium.

Next, a description will be given of various embodiments of the electronic equipment, the equipment managing apparatus, the equipment maintenance system, the equipment maintenance method and the computer-readable storage medium according to the present invention, by referring to the drawings.

[First Embodiment]

First, a description will be given of a first embodiment of the electronic equipment, the equipment managing apparatus, the equipment maintenance system, the equipment maintenance method and the computer-readable storage medium according to the present invention. In this embodiment, the present invention is applied to a case where the maintenance person goes to a setup site where the electronic equipment is set up.

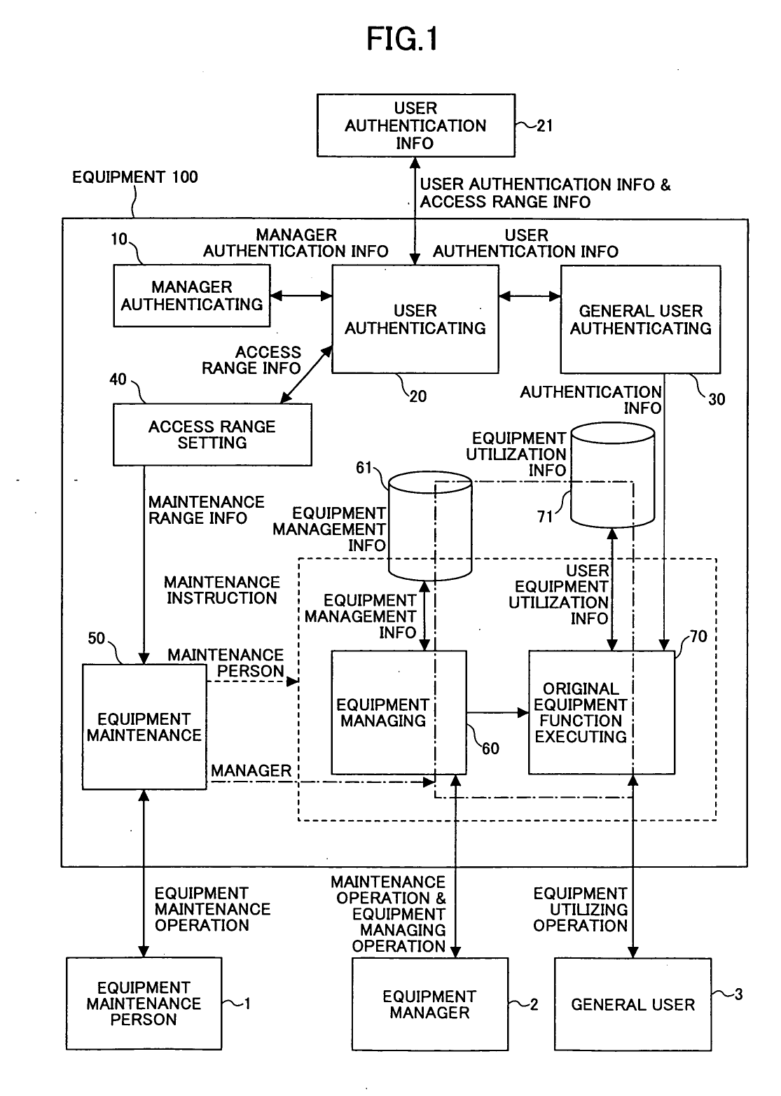

FIG. 1 is a diagram showing a structure of the electronic equipment for explaining this first embodiment. FIG. 1 shows the functional structure of the electronic equipment related particularly to management information and maintenance functions.

In FIG. 1, an electronic equipment 100 includes a manager authenticating part (or means) 10, a user authenticating part (or means) 20, a general user authenticating part (or means) 30, an access range setting part (or means) 40, an equipment maintenance part (or means) 50, an equipment managing part (or means) 60, and an original equipment function executing part (or means) 70. A portion or all of these parts (or means) 10, 20, 30, 40, 50, 60 and 70 may be realized by a computer having a known structure made up of a processor such as a CPU and an MPU and a memory for storing data and programs to be executed by the processor.

The electronic equipment (hereinafter also simply referred to as an equipment) 100 may be formed by any equipment or apparatus which may require maintenance. The equipment 100 may thus be selected from information processing apparatuses (hereinafter referred to as information equipments) including servers, general-purpose computers and personal computers; office automation equipments (OA equipments) including copying apparatuses, facsimile apparatuses, printing apparatuses and composite apparatuses; point-of-sales terminal equipments (POS terminal equipments); medical equipments; vending machines; electrical home appliances; and portable terminal equipments including portable telephones.

The manager authenticating part 10 has a function of authenticating that an operator (or user) is an equipment manager, based on manager authentication information supplied thereto. For example, it is possible to judge whether the operator is the equipment manager or the maintenance person, from a combination of a user name and a password.

The user authenticating part 20 authenticates the operator (or user) including an equipment maintenance person 1, an equipment manager 2 and a general user 3, from user authentication information and access range information supplied thereto. For example, a means for identifying the user from the user name and the password, a user ID and a personal identification number (PIN), an IC card and the like may be used as the user authenticating part 20.

User authentication information 21 includes the user authentication information and the access range information, and is used to authenticate the user including the equipment maintenance person 1, the equipment manager 2 and the general user 3. For example, information related to the user or information peculiar to the user, such as the user name and the password, the user ID and the PIN, user information and authentication information stored within the IC card, electronic information such as personal identification information and fingerprint information used for authentication, may be used as the user authentication information 21.

The general user authenticating part 30 authenticates that the operator (or user) is the general user 3 from the user authentication information supplied thereto. The authentication information obtained in the general user authenticating part 30 is supplied to the original equipment function executing part 70 which will be described later. For example, a means for confirming whether or not the operator is the correct general user 3 based on a combination of the user name and the password may be used as the general user authenticating part 30.

Accordingly, the manager authenticating part 10, the user authenticating part 20 and the general user authenticating part 30 form an authenticating part or means for authenticating validity of the maintenance-attending person who performs the maintenance.

A part or means for permitting maintenance within the predetermined maintenance range by the maintenance-attending person based on the authentication by the authenticating part or means, and a part of means for enabling the maintenance-attending person to know his permitted maintenance range, may further be provided separately. As will be described later, the predetermined maintenance range refers to the range in which the maintenance is permitted, where the setting, changing and temporary changing of the maintenance range is made by the access range setting part 40. The maintenance range may be set independently for each maintenance person based on a contract or the like.

For example, an IC card may be issued for each maintenance person, and the maintenance range in which the maintenance person is permitted to attend to the maintenance of the electronic equipment is stored in the IC card as additional information from an external server or the like, based on the contract or the like. When the maintenance person is authenticated using the IC card, this maintenance person cannot attend to the maintenance in the maintenance range which is set, changed or temporarily changed by the access range setting part 40, unless it is within the permitted maintenance range specified by the additional information stored in the IC card. By taking this measure, the security of the information within the electronic equipment is improved.

In order to enable the maintenance person to know this maintenance range, the maintenance range may be displayed on a touch panel of the operation part (or means) of the equipment 100, based on the information stored in the IC card.

Target ranges in which the maintenance and/or management of the equipment 100 is to be performed are set in the access range setting part 40 based on access range information supplied thereto. For example, the equipment maintenance person 1 may not perform the setting related to a network to which the equipment 100 connects, but the equipment manager 2 may perform the setting related to the network.

The access range setting part 40 functions as the part or means for setting, changing and temporarily changing the maintenance range of the equipment 100. The maintenance service provider (equipment maintenance person 1) for providing maintenance services for the equipment 100 and the manager (equipment manager 2) for managing the equipment 2, set, change and temporarily change the maintenance range using the access range setting part 40.

The equipment maintenance part 50 has a function of performing maintenance of the equipment 100, that is, a function of making settings and changes related to the maintenance. The settings made by the equipment maintenance part 50 originally are independent of the settings made by the user and peculiar to the equipment 100. However, depending on the setting, changing and temporary changing of the maintenance range and the permitted maintenance range of the equipment maintenance person 1, the equipment maintenance person 1 can perform the maintenance within the set, changed or temporarily changed maintenance range unless it is within the permitted maintenance range. The maintenance range information is supplied from the access range setting part 40 to the equipment maintenance part 50. In FIG. 1, a maintenance instruction from the equipment maintenance part 50 is indicated by a broken line for a case where the equipment maintenance person 1 performs the maintenance, and is indicated by a one-dot chain line for a case where the equipment manager 2 performs the maintenance.

The equipment managing part 60 has a function of managing the equipment 100, that is, a function of making settings and changes related to the management. Equipment management information for managing the equipment 100 is stored in a storage 61. Hence, the equipment managing part 60 carries out a network setting depending on the user environment, and sets and changes utilization information of the general user 3.

The original equipment function executing part 70 executes original target functions of the equipment 100. User equipment utilization information related to the utilization of the functions of the equipment 100 is stored in a storage 71. The storage 61 and the storage 71 may be formed by a single storage. For example, if the equipment 100 is a copying apparatus, the original equipment function executing part 70 executes copying functions including reading of a document and copying the read document image onto a recording sheet such as paper. If the equipment 100 is a medical imaging equipment, for example, the original equipment function executing part 70 executes imaging functions including generating a medial image.

In other words, if the equipment 100 is a printing apparatus, a means for providing printing functions such as printing document information received from another electronic equipment corresponds to the original equipment function executing part 70. If the equipment 100 is a facsimile apparatus, a means for providing facsimile functions such as transmitting via a telephone line document information which is optically read or is received from another electronic equipment corresponds to the original equipment function executing part 70. In addition, if the equipment 100 is an electrical home appliance, a means for providing functions such as reserving a television program according to video reservation information corresponds to the original equipment function executing part 70. Furthermore, if the equipment 100 is a medical equipment, a means for providing functions such as acquiring and generating medical data corresponds to the original equipment function executing part 70.

The people operating the equipment 100 may be roughly categorized into the general user 3 who uses the functions of the equipment 100 by making an equipment utilizing operation, the equipment manager 2 who manages the equipment 100 by making an equipment maintenance operation (or work) and an equipment managing operation (or work), and the equipment maintenance person 11 who attends to the maintenance of the equipment 100 by making an equipment maintenance operation (or work). The general user 3 and the equipment manager 2 belong to the organization or company environment in which the equipment 100 is set up. On the other hand, the equipment maintenance person 1 is the so-called service person belonging to the maintenance service provider who provides the maintenance services for the equipment 100.

The general user 3, the equipment manager (hereinafter simply referred to as a manager) 2 and the equipment maintenance person (hereinafter simply referred to as a maintenance person) 3 each indicate, with respect to the equipment 100, that the utilization of the equipment 100 is authorized or legitimate, using user information thereof. Hence, the equipment 100 authenticates the general user 3, the manager 2 and the maintenance person 1 based on the user information. If the general user 3, the manager 2 or the maintenance person 1 is authenticated by the equipment 100, utilization range setting information of the equipment 100 is further acquired, so as to enable utilization of the equipment 100 within a utilization range which is set by the utilization range setting information.

The authentication method is not limited to a specific method. For example, a method which sets an account name and a password or, a method which uses a personal authentication base which utilizes a public key infrastructure (PKI) provided by the maintenance service provider or the organization or company environment in which the equipment 100 is set up, may be employed as the authentication method. More particularly, an authentication system which combines a privacy (or enciphering) common key and a challenge response, an authentication system which combines a privacy key and a public key, and an authentication system which combines a privacy key, a public key and a challenge response may be employed as the authentication method.

The utilization range setting information includes not only the maintenance range, but also information related to the people (maintenance person and manager) permitted to perform the maintenance, the maintenance term and the target equipment.

It is desirable that the target equipment 100 can be specified or identified by information peculiar to the equipment or the like.

Since the maintenance person 1 may change, it is important to provide a means for confirming validity of the maintenance range set for the maintenance person 1 based on the maintenance term and the like.

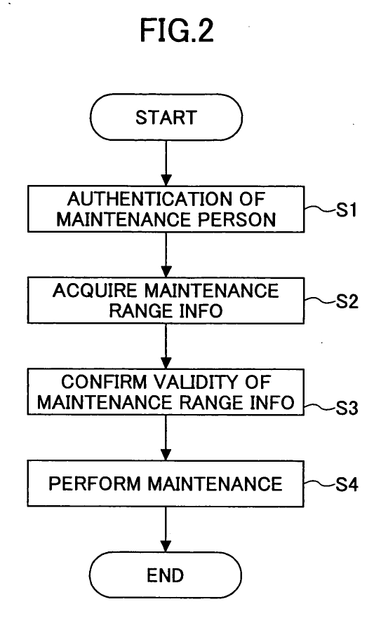

Next, a description will be given of a sequence up to the maintenance of the equipment 100, by referring to FIG. 2. FIG. 2 is a flow chart for explaining the maintenance of the electronic equipment 100 in this embodiment.

In FIG. 2, a step S1 carries out authentication of the maintenance person 1, and a step S2 acquires the maintenance range information. A step S3 confirms the validity of the maintenance range information, and a step S4 performs the maintenance of the equipment 100.

For example, as shown in FIG. 1, the maintenance may be performed within the maintenance range set by the manager 2 in the case of daily maintenance, and the maintenance person 1 may periodically set a maintenance range which is different from the above maintenance range and maintain the state of the equipment 100. When confirming the validity of the maintenance range information, it is possible to confirm the validity using an electronic signature added to the maintenance range information, for example.

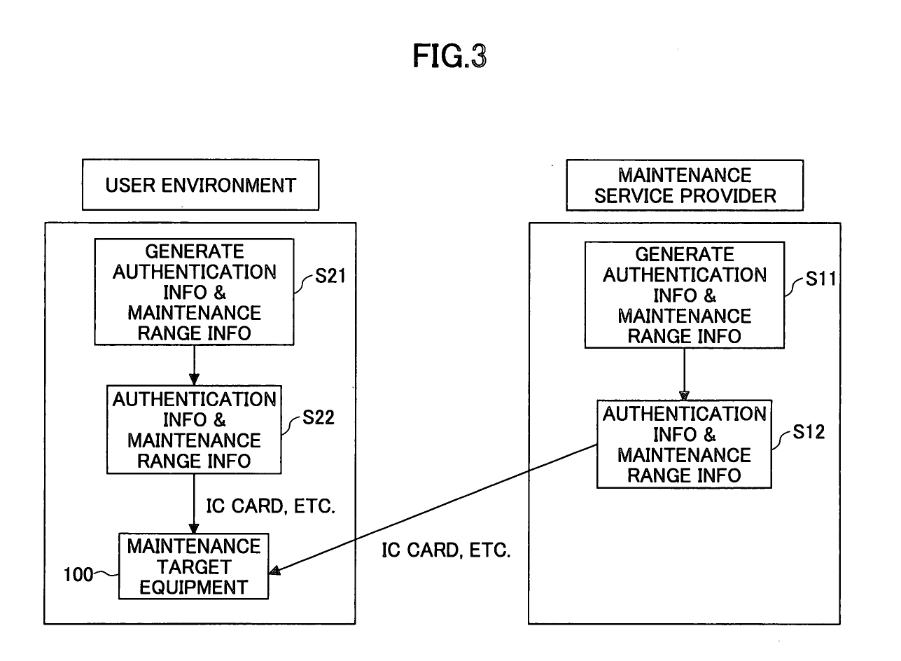

Next, a description will be given of a method of setting the authentication information and the maintenance range of the maintenance person 1 and the manager 2, by referring to FIG. 3. FIG. 3 is a diagram for explaining the setting of the authentication information and the maintenance range in this embodiment. In FIG. 3, the left portion indicates the user environment, and the right portion indicates the maintenance service provider.

When setting the information of the maintenance person 1, there is a first case where the maintenance service provider sets the authentication information and the maintenance range information, and a second case which uses the authentication information generated by the maintenance service provider and the maintenance range information set by the manager 2. In the first case, the maintenance range is set according to agreed contents, based on the contract or the like between the user and the maintenance person 1 (or maintenance service provider), which determines the maintenance range. The second case includes a case where the manager 2 sets the maintenance range and consigns the maintenance to the maintenance person 1 (or maintenance service provider), and a case where the manager 2 sets the maintenance range and performs the maintenance by himself. The authentication information and the maintenance range information are important information which are desirably managed with tight security. For this reason, it is desirable to store the authentication information and the maintenance range information in a physically tamper-safe medium such as an IC card.

In FIG. 3, steps S11 and S12 are carried out by an equipment or terminal, such as a computer, provided at the maintenance service provider, and set the authentication information and the maintenance range information with respect to the maintenance target equipment 100. Steps S21 and S22 are carried out by an equipment or terminal, such as a computer, set up in the user environment and operable by the manager 2, and set the authentication information and the maintenance range information with respect to the maintenance target equipment 100. When using the authentication information generated by the maintenance service provider and the maintenance range information set by the manager 2, the authentication information and the maintenance range information are set with respect to the maintenance target equipment 100 by the steps S11, S12, S21 and S22.

Therefore, according to this embodiment, a person can perform maintenance on the maintenance target equipment 100 only when the person is authenticated and the person indicates the set maintenance range by the maintenance range information. As a result, only the appropriate person can perform the maintenance within the appropriate maintenance range, and it is possible to prevent the privacy information and the like of the user from being accessed even by the maintenance person 1.

[Second Embodiment]

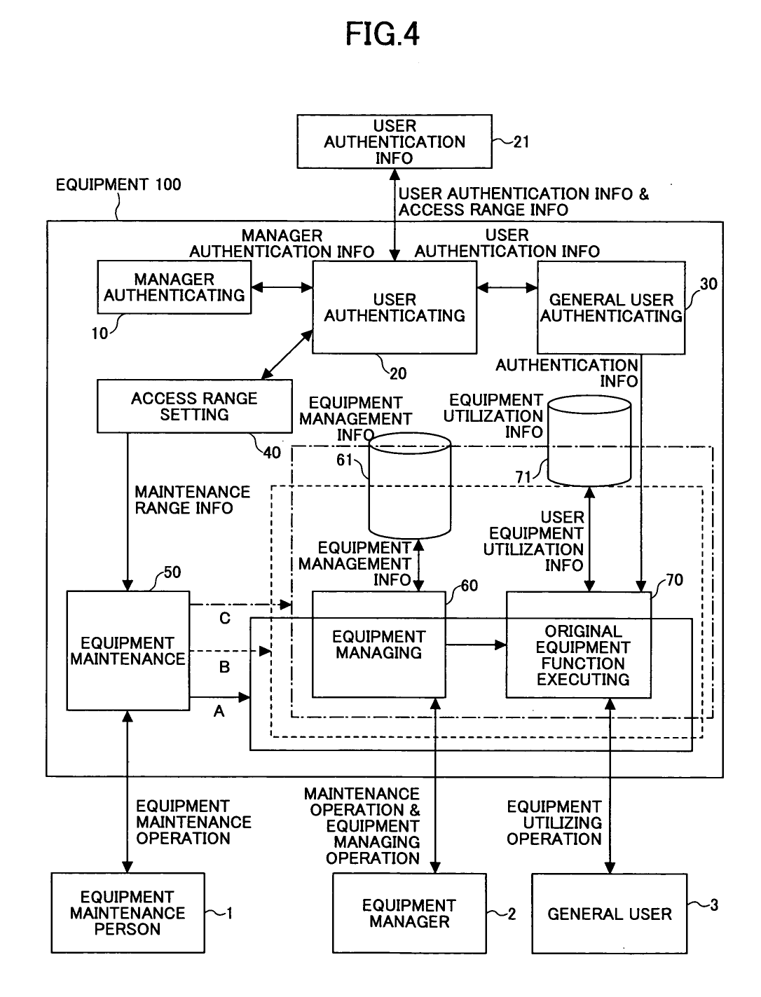

Next, a description will be given of a second embodiment of the electronic equipment, the equipment managing apparatus, the equipment maintenance system, the equipment maintenance method and the computer-readable storage medium according to the present invention, by referring to FIG. 4. FIG. 4 is a diagram showing a structure of the electronic equipment for explaining this second embodiment. FIG. 4 shows the functional structure of the electronic equipment related particularly to management information and maintenance functions. In FIG. 4, those parts which are the same as those corresponding parts in FIG. 1 are designated by the same reference numerals, and a description thereof will be omitted. This second embodiment temporarily changes the maintenance range.

When a failure is generated in the equipment 100, the required maintenance, restoration or repair work may exceed the normal maintenance range which is agreed upon beforehand, depending on the failure. For example, such a situation occurs when performing the maintenance, restoration or repair of a portion which is outside the normal maintenance range and is where the management information of the user is stored.

In this embodiment, the sequence up to the maintenance is the same as that shown in FIG. 2. First, the maintenance-attending person who is to perform the maintenance is authenticated in the step S1, and the maintenance range information is acquired to set the maintenance range in the step S2. Thereafter, the maintenance is performed in the step S4 depending on the set maintenance range. In this embodiment, it is assumed for the sake of convenience that there three kinds of maintenance ranges A, B and C, so that the maintenance of the portion can be performed in one of the maintenance ranges A, B and C depending on the generated failure.

The setting of the maintenance range information in this embodiment may be made similarly to FIG. 3, but in this embodiment, the terminal which sets the maintenance range is given the authority to set a maintenance range which exceeds the normal maintenance range which is set in advance. The maintenance range which exceeds the normal maintenance range may be set depending on the failure.

[Third Embodiment]

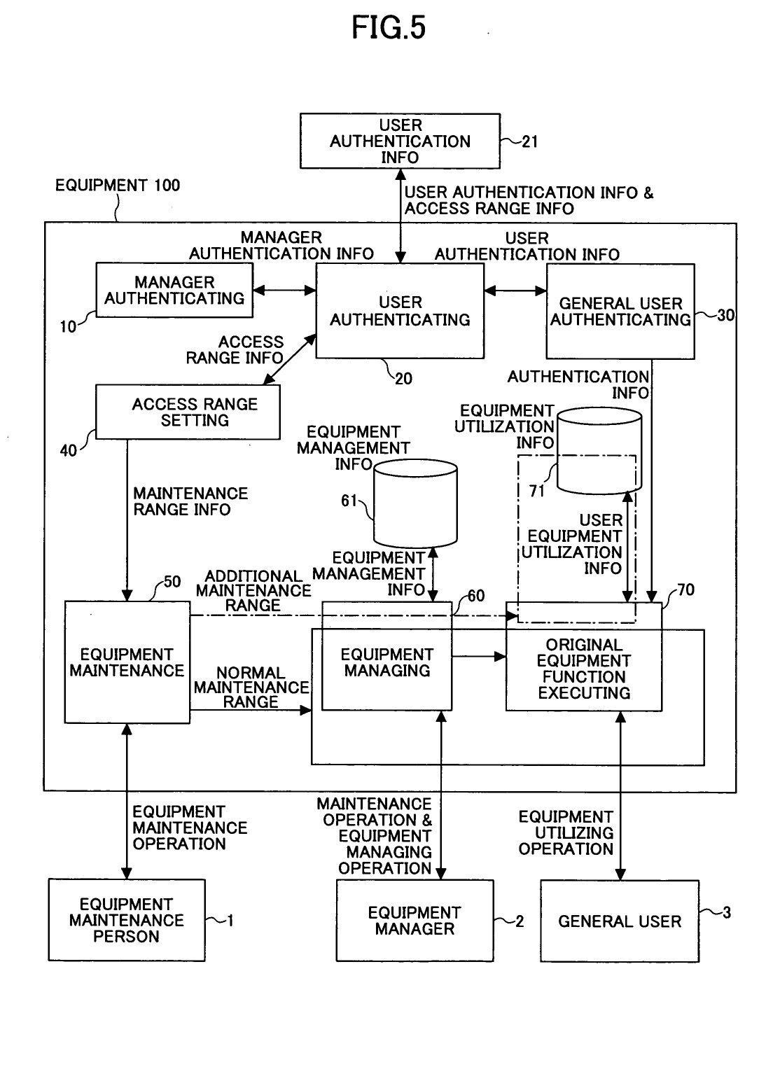

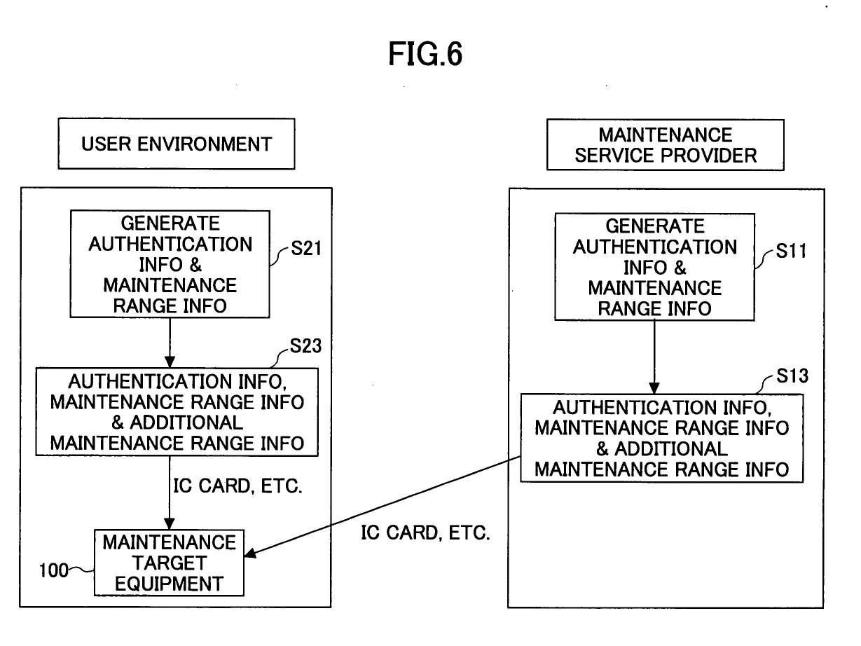

Next, a description will be given of a third embodiment of the electronic equipment, the equipment managing apparatus, the equipment maintenance system, the equipment maintenance method and the computer-readable storage medium according to the present invention, by referring to FIGS. 5 and 6.

FIG. 5 is a diagram showing a structure of the electronic equipment for explaining this third embodiment. FIG. 5 shows the functional structure of the electronic equipment related particularly to management information and maintenance functions. In FIG. 5, those parts which are the same as those corresponding parts in FIGS. 1 and 4 are designated by the same reference numerals, and a description thereof will be omitted. FIG. 6 is a diagram for explaining the setting of the authentication information and additional maintenance range information in this third embodiment. In FIG. 6, those parts which are the same as those corresponding parts in FIG. 3 are designated by the same reference numerals, and a description thereof will be omitted.

When temporarily changing the maintenance range, it is possible to employ a method which set the maintenance range by changing the definition of the maintenance range itself, a method which adds maintenance range information which is only valid temporarily or during a short period of time, or the like. The additional maintenance range information is set by the maintenance service provider or the manager 2, as shown in FIG. 6, and becomes valid when used together with the authentication information and the maintenance range information. The maintenance-attending person who performs the maintenance is not limited to the maintenance person 1 but may also be the manager 2. In this case, the maintenance range is increased in order to temporarily permit the maintenance person 1 and/or the manager 2 to perform the maintenance of the portion which is normally not permitted.

A description will be given of a method of setting the authentication information of the maintenance person 1 and the manager 2 and the additional maintenance range, by referring to FIG. 6. In FIG. 6, the left portion indicates the user environment, and the right portion indicates the maintenance service provider.

The additional maintenance range information is set by adding a temporarily valid maintenance range to the maintenance range information and the authentication information which are set in advance. The additional maintenance range information may be issued by the maintenance service provider or the by the manager 2.

In FIG. 6, steps S11 and S13 are carried out by the equipment, such as a computer, at the maintenance service provider, and set the authentication information, the maintenance range information and the additional maintenance range information with respect to the maintenance target equipment 100. Steps S21 and S23 are carried out by the equipment, such as a computer, set up in the user environment and operable by the manager 2, and set the authentication information, the maintenance range information and the additional maintenance range information with respect to the maintenance target equipment 100. When using the authentication information generated by the maintenance service provider and the maintenance range information set by the manager 2, the authentication information, the maintenance range information and the additional maintenance range information are set with respect to the maintenance target equipment 100 by the steps S11, S13, S21 and S23.

[Fourth Embodiment]

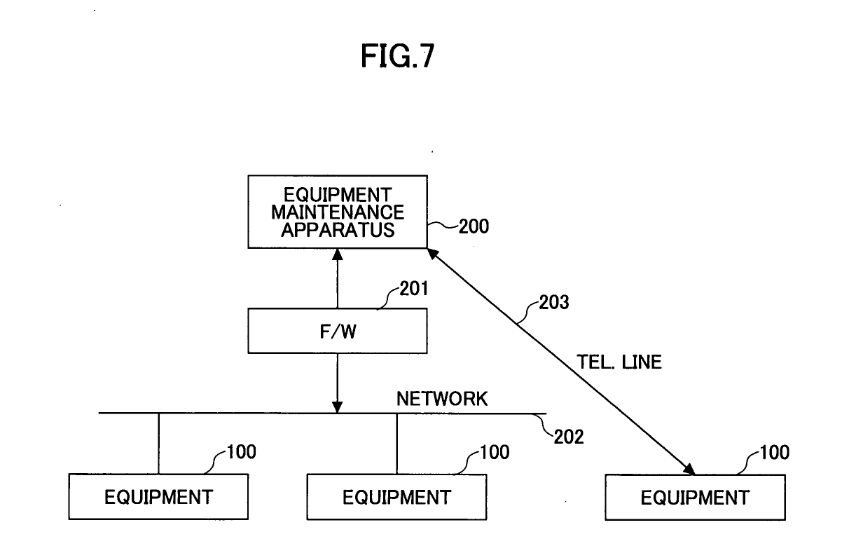

Next, a description will be given of a fourth embodiment of the electronic equipment, the equipment managing apparatus, the equipment maintenance system, the equipment maintenance method and the computer-readable storage medium according to the present invention, by referring to FIGS. 7 through 9. The maintenance may be performed not only by sending the maintenance person 1 directly to the site where the electronic equipment 100 is set up, but also by the so-called remote maintenance. The remote maintenance performs the maintenance from a remote location, remote from the site where the equipment 100 is set up, via a network, a telephone line or the like. In this embodiment, it is assumed for the sake of convenience that the remote maintenance performs on-line maintenance.

FIG. 7 is a system block diagram showing a structure of an equipment maintenance system of this embodiment. In FIG. 7, an equipment maintenance apparatus (or equipment managing apparatus) 200 is connected to equipments 100 via a firewall (F/W) 201 and a network 202. The equipment managing apparatus 200 is also connected to an equipment 100 via a telephone line 203. The network 202 and the telephone line 203 may be formed by cable, wireless or a combination of cable and wireless. Each equipment 100 which is connected to the network 202 may be accessed from the external equipment managing apparatus 200 which is set up at a remote location from each equipment 100, and the remote maintenance of each equipment 100 may be made from the equipment managing apparatus 200. Of course., a firewall (F/W) may also be provided between the network 202 and each equipment 100.

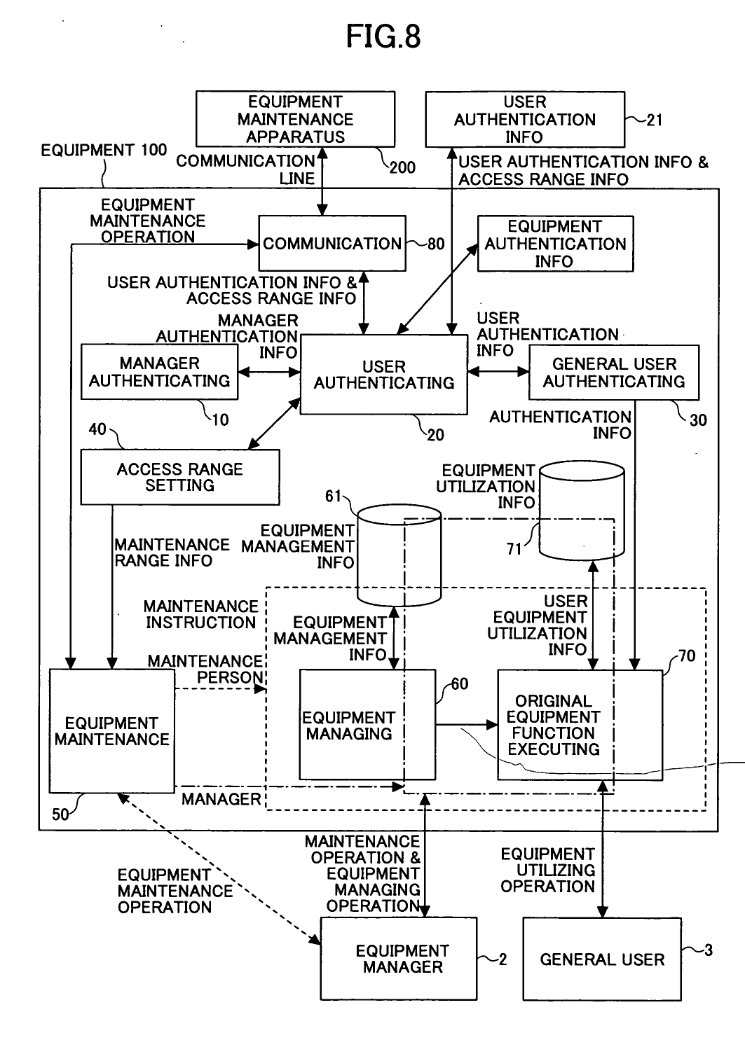

FIG. 8 is a diagram showing a structure of the electronic equipment for explaining this fourth embodiment. In FIG. 8, those parts which are the same as those corresponding parts in FIGS. 1, 4 and 5 are designated by the same reference numerals, and a description thereof will be omitted.

The electronic equipment 100 shown in FIG. 8 has a basic structure similar to those shown in FIGS. 1, 4 and 5, but a communication part (or means) 80 is provided in this embodiment. In other words, the maintenance person 1 visits the user and performs the on-site maintenance in the cases shown in FIGS. 1, 4 and 5, but the maintenance person 1 can perform the on-line maintenance, that is, the remote maintenance, without having to actually visit the user. For this reason, the equipment 100 shown in FIG. 8 is connected to the equipment managing apparatus 200 via the communication part 80 and the network 202 or the telephone line 203. Of course, the communication part 80 may be provided in the equipment 100 shown in any of FIGS. 1, 4 and 5.

In this embodiment, it is necessary to carry out an on-line authentication of the equipment 100 and the equipment managing apparatus 200, and thus, the authentication must be made via the communication part 80. Thereafter, the equipment managing apparatus 200 authenticates the maintenance person 1 via the network 202 or a communication line such as the telephone line 203, sets the maintenance range, and performs the remote maintenance.

First, a mutual authentication is carried out in order to confirm the legitimacy of the maintenance person 1 or the equipment managing apparatus 200 to perform the maintenance, and to confirm the legitimacy of the maintenance target equipment 100. An authentication system using a combination of a privacy common key and a challenge response, an authentication system using a combination of a privacy key and a public key, an authentication system using a combination of a privacy key, a public key and a challenge response, and the like may be employed as the method of the mutual authentication.

In this embodiment, the sequence up to the maintenance is basically the same as that shown in FIG. 2, but the mutual authentication is made to confirm the maintenance target equipment 100 and the equipment managing apparatus 200 or, to confirm that the maintenance-attending person is not impersonating the maintenance person 1, before acquiring the maintenance range information and confirming legitimacy or validity thereof to perform the maintenance. In addition, since this embodiment performs the remote maintenance from the remote location via the communication line, it is desirable to encipher the information which is transmitted and received, in a case where the safety of the communication cannot be secured. In addition, even when not enciphering the information which is transmitted and received, it is desirable to add a message authenticator to the information in order to guarantee the safety of the information which is transmitted and received.

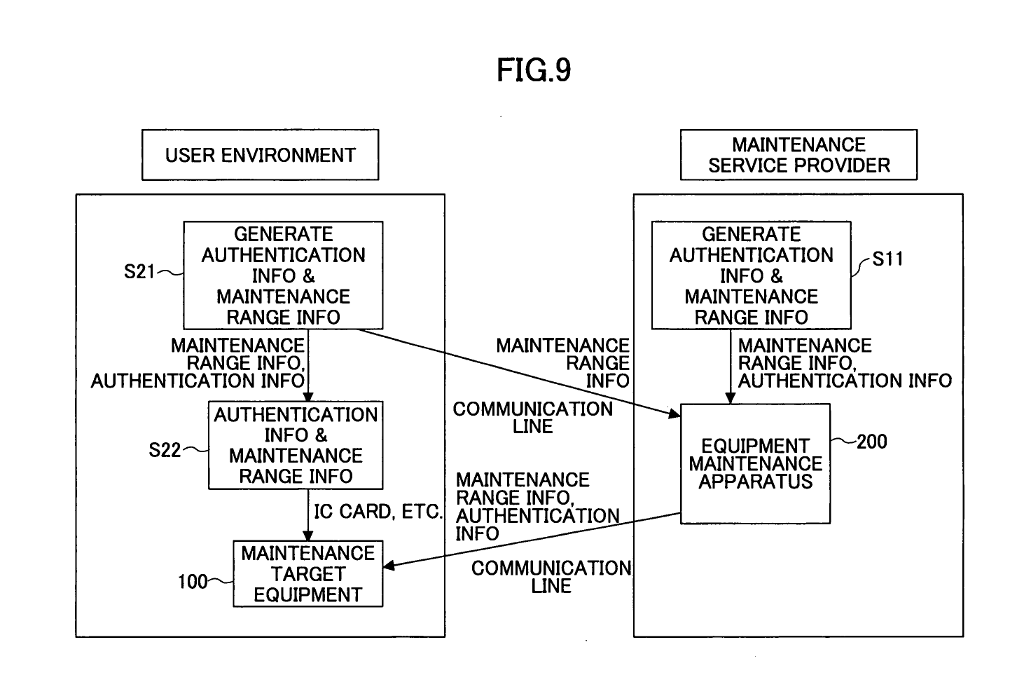

Next, a description will be given of the generation of the authentication information and the maintenance range information in this fourth embodiment, by referring to FIG. 9. FIG. 9 is a diagram for explaining the setting of the authentication information and maintenance range information in this fourth embodiment. In FIG. 9, those parts which are the same as those corresponding parts in FIGS. 3 and 6 are designated by the same reference numerals, and a description thereof will be omitted. In FIG. 9, the left portion indicates the user environment, and the right portion indicates the maintenance service provider.

In order to perform the on-line maintenance via the communication line, it is important to authenticate each equipment 100 and to authenticate the maintenance person 1 who provides the on-line maintenance services. Information for the authentications may be set in each equipment 100 at the stage where the equipment 100 is manufactured or, when setting up the equipment 100.

The maintenance service provider generates the authentication information with respect to the maintenance person 1. The maintenance range information with respect to the maintenance person 1 is issued by the maintenance service provider or the manager 2, and sent to the equipment managing apparatus 200 which performs the maintenance. When sending the maintenance range information to the equipment managing apparatus 200 from the equipment or terminal at the user end which generates the authentication information and the maintenance range information, it is desirable to make the mutual authentication between the equipment managing apparatus 200 and the equipment 100, encipher the information which is transmitted and received and secure safety, in order to prevent a person from impersonating the maintenance person 1.

When performing the maintenance on the equipment 100, the mutual authentication is first made between the equipment managing apparatus 200 and the maintenance target equipment 100 using the authentication information. Thereafter, the equipment managing apparatus 200 indicates the maintenance range information. The maintenance target equipment 100 confirms the legitimacy of the indicated maintenance range information, and sets the maintenance range. When the temporary additional maintenance range information exists as in the case of the third embodiment described above, the additional maintenance range information is indicated similarly, and the maintenance range is added. The maintenance is performed within the set maintenance range from the equipment managing apparatus 200 set up at the remote location.

In FIG. 9, the step S11 is carried out by the equipment, such as a computer, at the maintenance service provider, and sets the authentication information and the maintenance range information with respect to the equipment managing apparatus 200. Accordingly, the equipment managing apparatus 200 sets the authentication information and the maintenance range information with respect to the maintenance target equipment 100 via the communication line. Steps S21 and S22 are carried out by the equipment, such as a computer, set up in the user environment and operable by the manager 2, and set the authentication information and the maintenance range information with respect to the maintenance target equipment 100. The maintenance range information generated by the step S21 is supplied to the equipment managing apparatus 200 via the communication line. When using the authentication information generated by the maintenance service provider and the maintenance range information set by the manager 2, the authentication information and the maintenance range information are set with respect to the maintenance target equipment 100 by the steps S11, S21 and S22 and the equipment managing apparatus 200.

According to the above described procedure, it is possible to positively perform the maintenance from the remote location while securing the safety requested by the user.

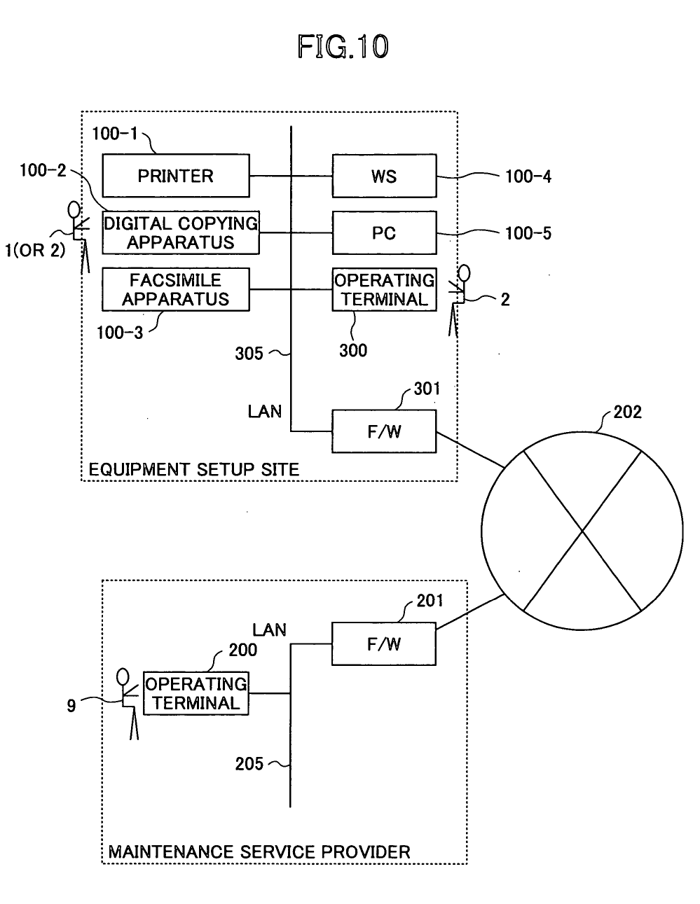

Next, a description will be given of system which may be applied with each of the embodiments described above, by referring to FIG. 10 and the subsequent drawings.

1: Maintenance Range Setting Procedure

FIG. 10 is a system block diagram showing a system which may be applied with the first embodiment described above. In FIG. 10, those parts which are the same as those corresponding parts in FIGS. 1 and 7 are designated by the same reference numerals, and a description thereof will be omitted.

In FIG. 10, an operating terminal 300, a printer 100-1, a digital copying apparatus 100-2, a facsimile apparatus 100-3, a work station (WS) 100-4 and a personal computer (PC) 100-5 which are provided as maintenance target equipments 100, are provided in the user environment (equipment setup site) and connected to a network 202 such as the Internet, via a LAN 305 and a firewall (F/W) 301. The operating terminal 300 is formed by a personal computer, for example, and is operated by the manager 2. On the other hand, in the maintenance service provider, the equipment managing apparatus (operating terminal) 200 is connected to the network 200 via a LAN 205 and the firewall (F/W) 201. In FIG. 10, a maintenance-attending person or an operator at the maintenance service provider is denoted by a reference numeral 9.

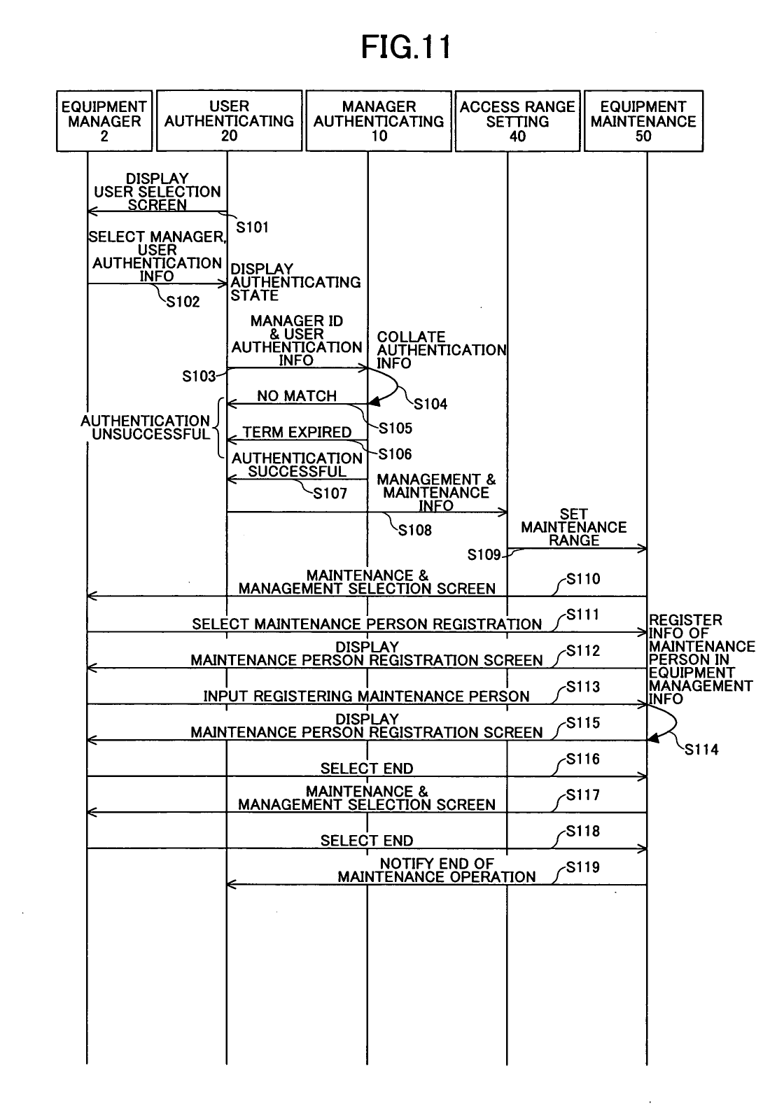

FIG. 11 is a flow chart for explaining an embodiment of a maintenance range setting procedure. In this case, it is assumed for the sake of convenience that the manager 2 sets in advance the maintenance person 1 for the maintenance target equipment 100 and the maintenance range in which the maintenance person 1 is permitted to perform the maintenance of the maintenance target equipment 100. In addition, it is assumed that the manager authenticating part 10, the user authenticating part 20, the access range setting part 40 and the equipment maintenance part 50 shown in FIG. 11 are provided within the maintenance target equipment 100, and that the maintenance target equipment 100 is provided with an input part and a display part (both not shown). The input part and the display part may be formed by a touch panel which integrally includes the input part and the display part.

The user authenticating part 20 displays a user selection screen on the display part in a step S101. The manager 2 makes inputs from the input part related to the selection of the equipment manager and the manager information (ID, password, etc.) in a step S102, so as to supply user authentication information 21 to the user authenticating part 20.

The user authenticating part 20 displays a message or the like to indicate the authenticating state on the display part, and supplies the manager authentication information of the user authentication information 21 to the manager authenticating part 10, in a step S103. The manager authenticating part 10 collates the manager authentication information with the authentication information which is related to the manager and is included in the equipment manager information registered in advance in a database (not shown) stored in the storage 61 or the like within the equipment 100, in a step S104. If the collated authentication information do not match, the manager authenticating part 10 notifies this to the user authenticating part 20 in a step S105. If the collated authentication information match, the manager authenticating part 10 acquires the permitted management and maintenance information as the attribute information of the authenticated (permitted) manager 2. The management and maintenance information includes the management and maintenance range, the maintenance term and the like. The manager authenticating part 10 decides whether or not the maintenance term included in the management and maintenance information is expired, and if the decision result is YES, notifies the user authenticating part 20 that the maintenance term is expired, in a step S106. In other words, in the case where the step S105 or S106 is carried out, the manager authentication has failed, the setting of the maintenance range cannot be made, and the display on the display part is returned to the user selection screen.

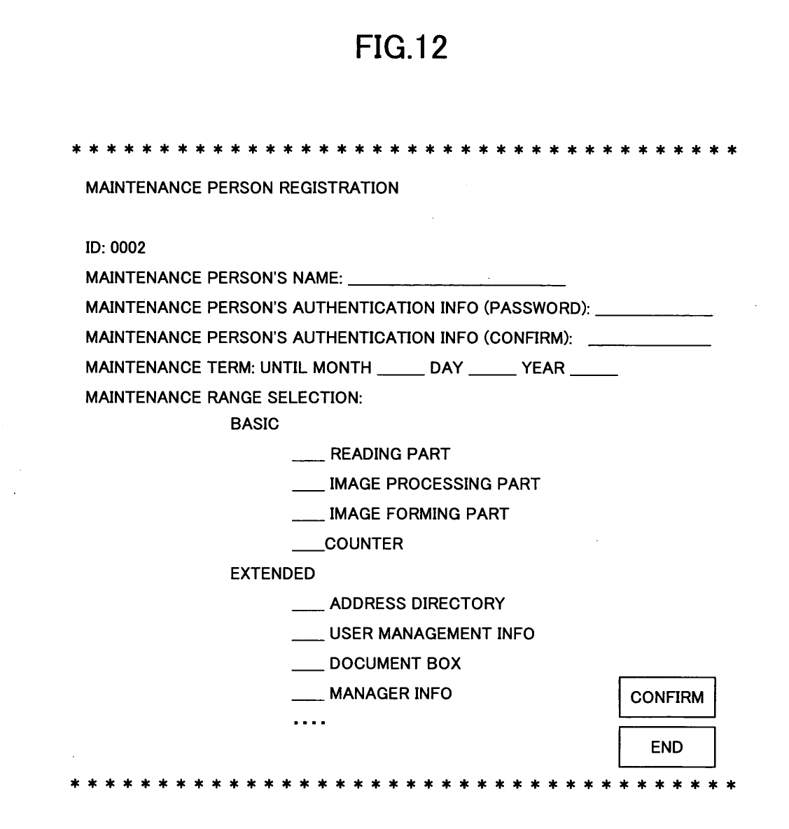

On the other hand, if the maintenance term is not expired, the manager authenticating part 10 notifies the user authenticating part 20 that the manager authentication was successful, in a step S107. In this case, the user authenticating part 20 supplies the management and maintenance information including the access range information to the access range setting part 40, in a step S108. The access range setting part 40 supplies the maintenance range information to the equipment maintenance part 50 to set the maintenance range, in a step S109. The equipment maintenance part 50 displays a maintenance and management selection screen on the display part in a step S110, and the manager 2 selects a maintenance person registration from the input part with respect to the equipment maintenance part 50, in a step S111. In response to the selection of the maintenance person registration, the equipment maintenance part 50 displays a maintenance person registration screen shown in FIG. 12 on the display part, in a step S112.

FIG. 12 is a diagram showing the maintenance person registration screen displayed on the display part. As shown in FIG. 12, the maintenance person registration screen includes an ID of the maintenance person, the name of the maintenance person (name of person in charge of maintenance), the authentication information of the maintenance person (maintenance person authentication information), the maintenance term, and the maintenance range selection. Because FIG. 12 shows the maintenance person registration screen for a case where the maintenance target equipment 100 is the digital copying apparatus 100-2, the maintenance range selection includes basic selection and extended selection. The basic selection enables selection of the reading part and the like as the maintenance range. The extended selection enables selection of the address directory and the like as the maintenance range.

When the manager 2 inputs the name of the maintenance person, the maintenance term, the maintenance range and the like to be registered from the input part, while monitoring the maintenance person registration screen shown in FIG. 12, and selects a confirm button in a step S113, the input information is supplied to the equipment maintenance part 50. The equipment maintenance part 50 registers the information of the maintenance person in the equipment management information which is managed by the equipment managing part 60, in a step S114. In addition, the equipment maintenance part 50 again displays the maintenance person registration screen shown in FIG. 12 on the display part in a step S115. When the manager 2 selects an end button the maintenance person registration screen in a step S116, the end of the maintenance person registration is notified to the equipment maintenance part 50. In response to the end notification of the maintenance person registration, the equipment maintenance part 50 displays a maintenance and management selection screen on the display part in a step S117. When the manager 2 selects an end button on the maintenance and management selection screen in a step S118, the end notification of the maintenance and management selection is notified to the equipment maintenance part 50. In response to the end notification of the maintenance and management selection, the equipment maintenance part 50 notifies an end of the maintenance range setting procedure to the user authenticating part 20, in a step S119.

In a case where the maintenance person registration is not included in the maintenance range, the maintenance person cannot be registered, and the steps S110 through S119 are not carried out.

2.1: Maintenance Procedure

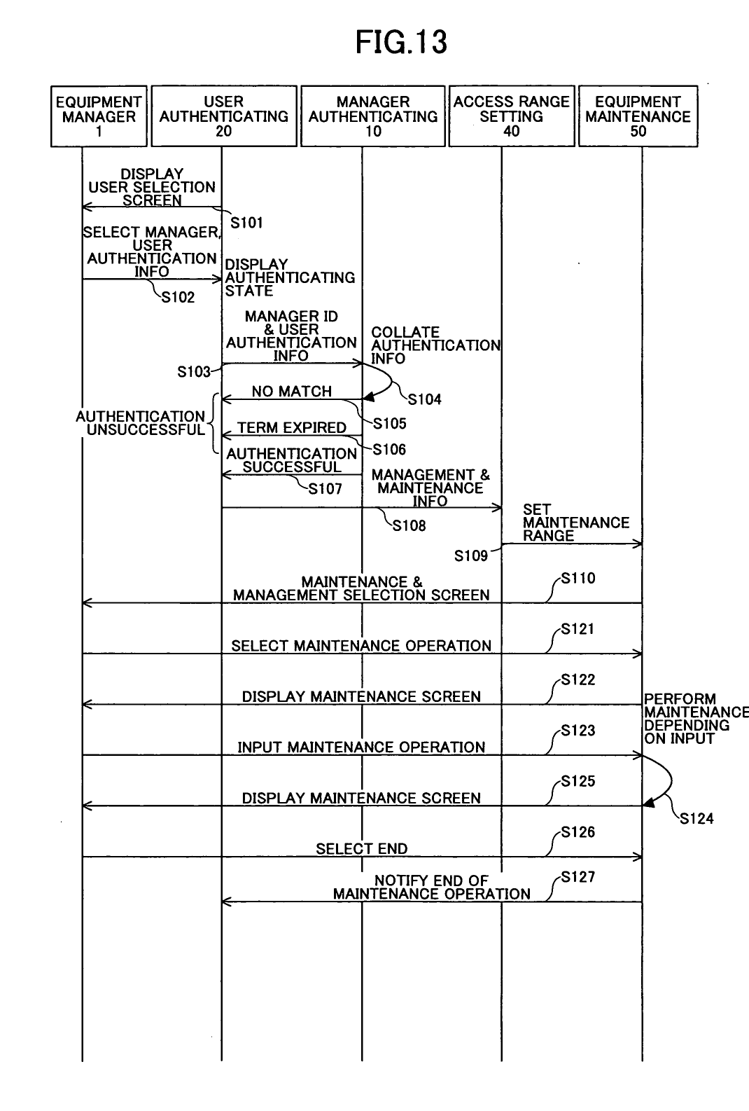

FIG. 13 is a flow chart for explaining an embodiment of the maintenance procedure. In FIG. 13, those steps which are essentially the same as those corresponding steps in FIG. 11 are designated by the same reference numerals, and a description thereof will be omitted. In this case, the operator of the equipment 100 is the maintenance person 1 and not the manager 2. It is assumed for the sake of convenience that the information (ID, password, etc.) for identifying the maintenance person 1 is stored within the manager authenticating part 10 or, the equipment management information including the information for identifying the maintenance person 1 is registered in advance in a database stored the storage 61 or the like within the equipment 100, which is accessible from the manager authenticating part 10. Accordingly, it is possible to authenticate the maintenance person 1 by collating the ID and the password of the maintenance person 1. The maintenance person 1 for performing the maintenance of the equipment 100 goes to the equipment setup site where the equipment 100 is set up, and performs the maintenance after being authenticated by the equipment 100 within the permitted maintenance range.

In FIG. 13, the manager authenticating part 10 acquires the permitted maintenance information, as the attribute information of the authenticated (permitted) maintenance person 1, if the collated authentication information match in the step S104. The maintenance information includes the maintenance range, the maintenance term and the like. The manager authenticating part 10 decides whether or not the maintenance term included in the maintenance information is expired, and if the decision result is YES, notifies the user authenticating part 20 that the maintenance term is expired, in the step S106.

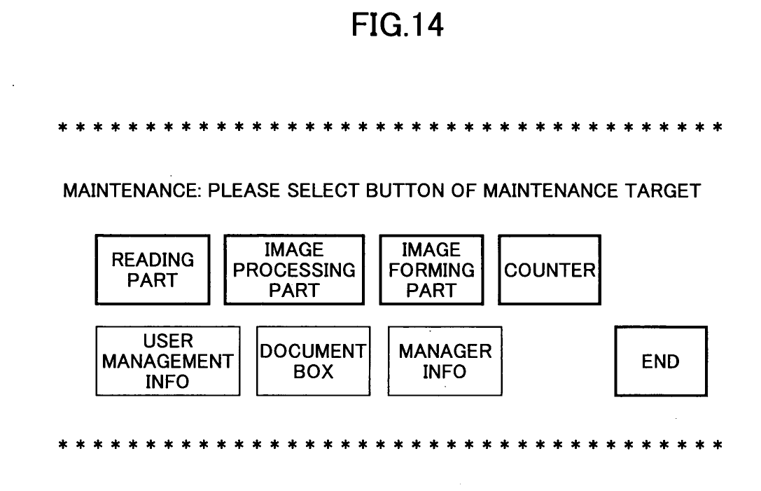

After the step S110, steps S121 through S127 are carried out. The maintenance person 1 selects a maintenance work on the maintenance and management selection screen which is displayed on the display part, from the input part, in the step S121, and the selected maintenance work is notified to the equipment maintenance part 50. The equipment maintenance part 50 displays a maintenance work input screen shown in FIG. 14 on the display part within the maintenance range, in the step S122.

FIG. 14 is a diagram showing the maintenance work input screen. Because FIG. 14 shows the maintenance work input screen for the case where the maintenance target equipment 100 is the digital copying apparatus 100-2, the reading part, the image processing part and the like are selectable on the maintenance work input screen as the maintenance target.

When the maintenance person 1 selects the maintenance target on the maintenance work input screen, from the input part, and selects an end button in the step S122, the selected maintenance target is notified to the equipment maintenance part 50. The equipment maintenance part 50 performs maintenance with respect to the selected maintenance target, in the step S124, and displays a maintenance screen on the display part, in the step S125. When the maintenance person 1 selects an end button on the maintenance screen in the step S126, the end of the maintenance work is notified to the equipment maintenance part 50, and the equipment maintenance part 50 notifies the end of the maintenance work to the user authenticating part 20 in the step S127.

2.2: Maintenance Procedure

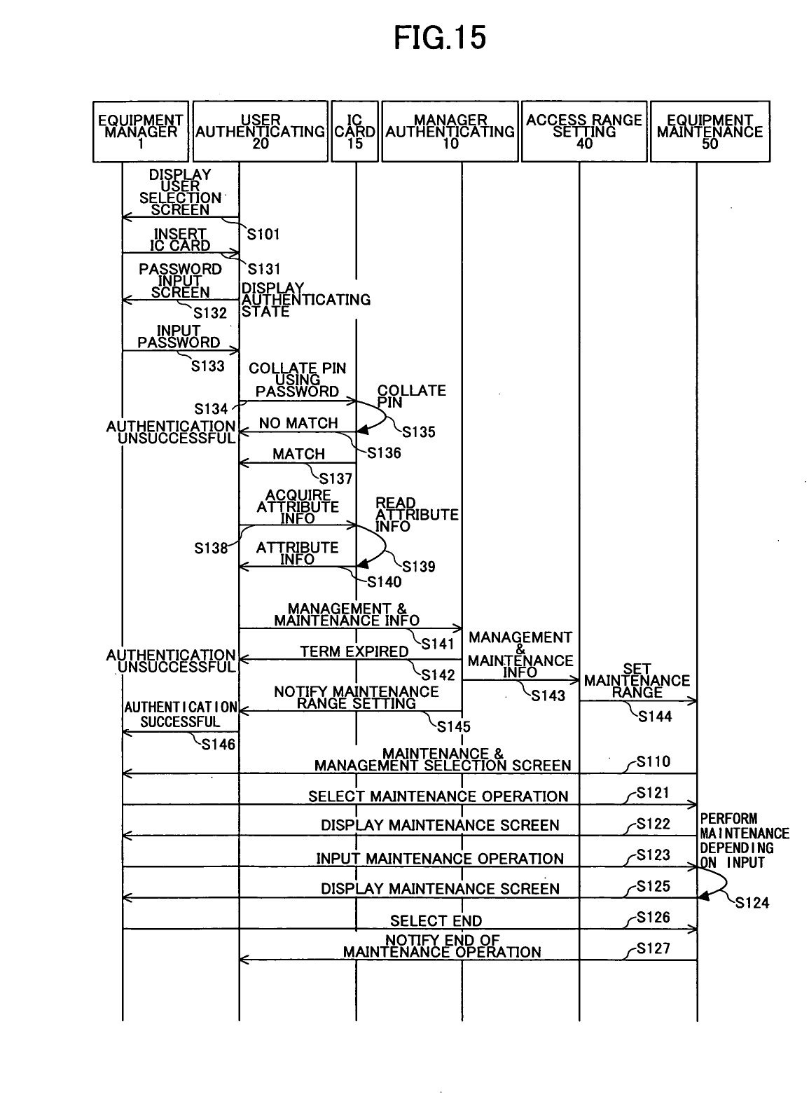

FIG. 15 is a flow chart for explaining another embodiment of the maintenance procedure. In FIG. 15, those steps which are essentially the same as those corresponding steps in FIG. 13 are designated by the same reference numerals, and a description thereof will be omitted. In this case, it is assumed for the sake of convenience that the an IC card 15 for authenticating the maintenance person 1 is issued by the equipment managing apparatus 200 of the maintenance service provider, and that the maintenance person 1 is authenticated by using the issued IC card 15 in the maintenance target equipment 100. In addition, it is assumed for the sake of convenience that the user authenticating part 20 shown in FIG. 1 is provided with an IC card reader and writer (not shown) having a known structure. Hence, it is possible to authenticate the maintenance person 1 by reading the password (PIN: Personal Identification Number information) which is stored in the IC card 15 by the IC card writer and reader to be collated with the registered authentication information. The maintenance person 1 for performing the maintenance of the equipment 100 goes to the equipment setup site where the equipment 100 is set up, and performs the maintenance after being authenticated by the equipment 100 within the permitted maintenance range. Of course, an IC card may be issued similarly with respect to the manager 2.

In FIG. 15, the maintenance person 1 inserts the IC card 15 into the IC card reader and writer of the maintenance target equipment 100, in a step S131. The user authenticating part 20 displays a message or the like to indicate the authenticating state on the display part, and displays a password input screen on the display part to urge the maintenance person 1 to input the password (PIN information), in a step S132. When the maintenance person 1 inputs the password from the input part in a step S133, the password is supplied to the user authenticating part 20.

The user authenticating part 20 supplies the password (PIN information) which is input to the IC card 15 in a step S134, and collates the PIN information with the PIN information which is stored in the IC card 15 in a step S135. If the collated PIN information do not match, the IC card 15 notifies this to the user authenticating part 20 in a step S136. When the step S136 is carried out, the authentication of the maintenance person 1 has failed, and thus, no maintenance work is performed, and the display on the display part returns to the user selection screen. On the other hand, if the collated PIN information match, the IC card 15 notifies this to the user authenticating part 20 in a step S137. In this case, the user authenticating part 20 makes an access to the IC card 15 in a step S138, and reads the permitted maintenance information from the IC card 15 as the attribute information of the authenticated (permitted) maintenance person 1 in a step S139. The maintenance information read from the IC card 15 is supplied to the user authenticating part 20 in a step S140.

The user authenticating part 20 received from the maintenance information supplied from the IC card 15 to the manager authenticating part 10 in a step S141. If the maintenance term included in the maintenance information is expired, the manager authenticating part 10 notifies this to the user authenticating part 20 in a step S142. When the step S142 is carried out, the authentication of the maintenance person 1 has failed, and thus, no maintenance work is performed, and the display on the display part returns to the user selection screen. On the other hand, if the maintenance term included in the maintenance information is not expired, the manager authenticating part 10 supplies the maintenance information to the access range setting part 40 and sets the maintenance range in a step S143. In addition, the access range setting part 40 supplies the maintenance range information to the equipment maintenance part 50 in a step S144.

The manager authenticating part 10 makes a maintenance range set notification to the user authenticating part 20 in a step S145. The user authenticating part 20 which receives the maintenance range set notification displays a message or the like indicating that the maintenance person 1 is authenticated (that is, the authentication was successful) on the display part in a step S146. The process after the step S110 is the same as that shown in FIG. 13.

2.3: Maintenance Procedure

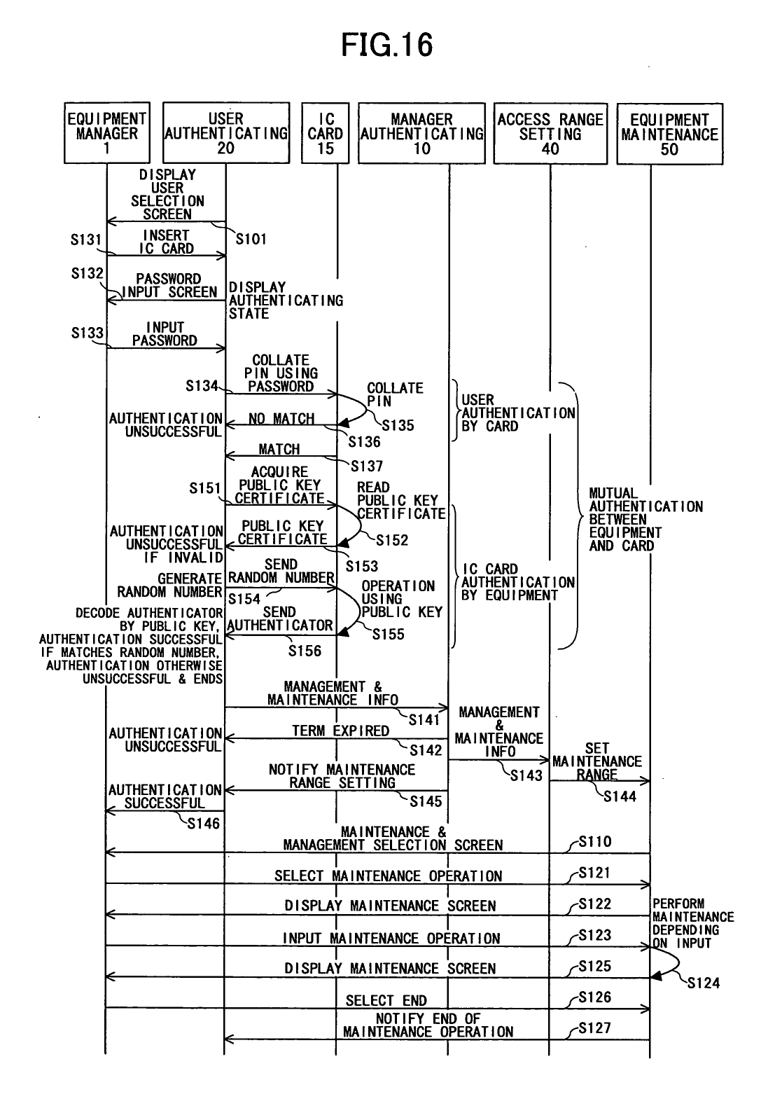

FIG. 16 is a flow chart for explaining another embodiment of the maintenance procedure. In FIG. 16, those steps which are essentially the same as those corresponding steps in FIG. 15 are designated by the same reference numerals, and a description thereof will be omitted. In this case, it is assumed for the sake of convenience that the IC card 15 for authenticating the maintenance person 1 is issued by the equipment managing apparatus 200 of the maintenance service provider, and that the maintenance person 1 is authenticated by using the issued IC card 15 in the maintenance target equipment 100. In addition, it is assumed for the sake of convenience that the user authenticating part 20 shown in FIG. 1 is provided with an IC card reader and writer (not shown) having a known structure. Hence, it is possible to authenticate the maintenance person 1 by reading the password (PIN: Personal Identification Number information) and a public key certificate which are stored in the IC card 15 by the IC card writer and reader to be collated with the registered authentication information and public key certificate. The maintenance person 1 for performing the maintenance of the equipment 100 goes to the equipment setup site where the equipment 100 is set up, and performs the maintenance after being authenticated by the equipment 100 within the permitted maintenance range. Of course, an IC card may be issued similarly with respect to the manager 2.

In FIG. 16, after the step S137, the user authenticating part 20 requests the public key certificate stored in the IC card 15 in a step S151, and reads the public key certificate in a step S152. The read public key certificate is supplied to the user authenticating part 20 in a step S153, and is collated with the public key certificate which is registered in advance, so as to determine the legitimacy of the IC card 15. For example, if the public key certificate is invalid or the valid term is expired, the authentication fails and the process returns to the step S101. The registered public key certificate may be stored within the manager authenticating part 10 or the like within the equipment 100 or, within the operating terminal 300 or, within the external equipment managing apparatus 200.

When the authentication using the public key certificate is successful, the user authenticating part 20 generates and supplies a random number to the IC card 15 in a step S154. An operation is carried out with respect to the random number using the public key, so as to generate an authenticator in a step S155. This authenticator is supplied to the user authenticating part 20 in a step S156. The authenticator is decoded using the registered public key, and the authentication is successful if the decoded value matches the random number generated by the user authenticating part 20, and the authentication fails if the decoded value does not match the random number generated by the user authenticating part 20. If the authentication fails, the process returns to the step S101. On the other hand, if the authentication is successful, the process of the step S141 and the subsequent state is carried out.

Accordingly, the maintenance person 1 is authenticated by the IC card 15 in the steps S132 through S137, and the IC card 15 of the maintenance person 1 is authenticated by the equipment 100 by the steps S151 through S156. Therefore, a mutual authentication procedure between the equipment 100 and the IC card 15 is carried out by the steps S132 through S137 and the steps S151 through S156. Of course, it is possible to carry out the steps S151 through S156 before the steps S132 through S137.

2.4: Maintenance Procedure

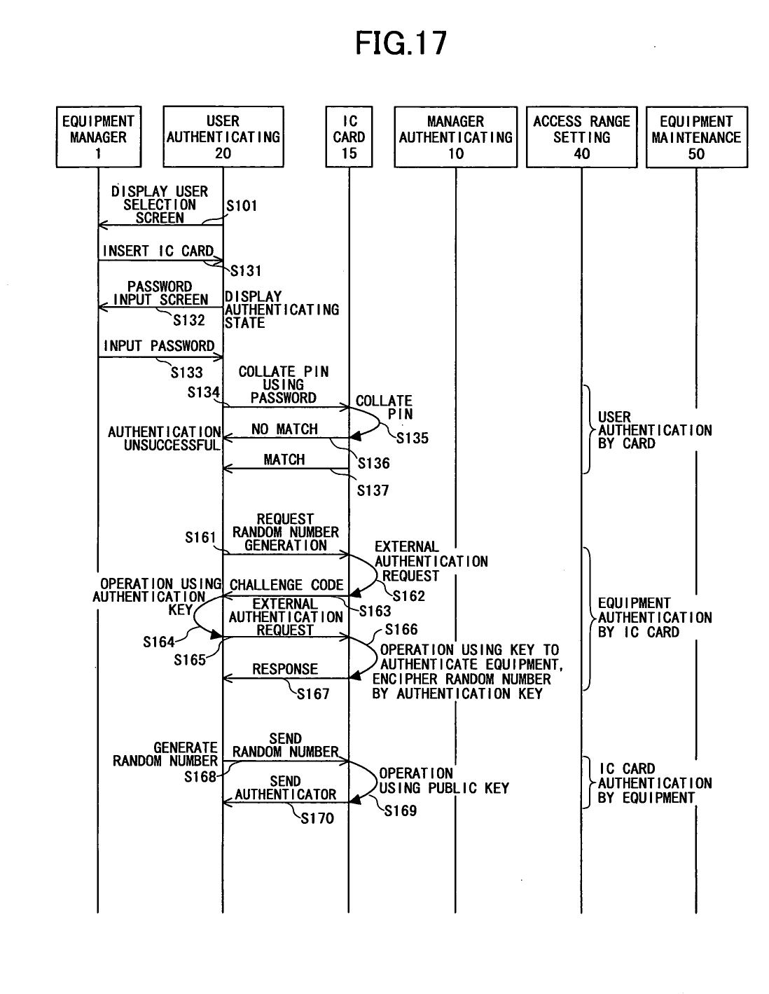

FIG. 17 is a flow chart for explaining another embodiment of the maintenance procedure. In FIG. 17, those steps which are essentially the same as those corresponding steps in FIG. 15 are designated by the same reference numerals, and a description thereof will be omitted. In this case, it is assumed for the sake of convenience that the IC card 15 for authenticating the maintenance person 1 is issued by the equipment managing apparatus 200 of the maintenance service provider, and that the maintenance person 1 is authenticated by using the issued IC card 15 in the maintenance target equipment 100. In addition, it is assumed for the sake of convenience that the user authenticating part 20 shown in FIG. 1 is provided with an IC card reader and writer (not shown) having a known structure. Hence, it is possible to authenticate the maintenance person 1 by reading the password (PIN: Personal Identification Number information) and an authentication key which are stored in the IC card 15 by the IC card writer and reader to be collated with the registered authentication information and authentication key. The maintenance person 1 for performing the maintenance of the equipment 100 goes to the equipment setup site where the equipment 100 is set up, and performs the maintenance after being authenticated by the equipment 100 within the permitted maintenance range. Of course, an IC card may be issued similarly with respect to the manager 2.

In FIG. 17, after the step S137, the user authenticating part 20 makes a random number generation request with respect to the IC card 15 in a step S161. A random number is generated in a step S162. The generated random number is supplied to the user authenticating part 20 as a challenge code, in a step S163. The user authenticating part 20 carries out an operation with respect to the challenge code using a privacy key which is registered in advance within the equipment 100, so as to generate an authenticator in a step S164. The user authenticating part 20 makes an external authentication request with respect to the IC card 15 in a step S165. An authenticator is generated in a step S166, by carrying out an operation with respect to the random number generated in the step S162 using the authentication key which is for authenticating the equipment 100 and is stored in the IC card 15. The authentication is successful if the generated authenticator matches the authenticator received from the user authenticating part 20, and the authentication fails if the generated authenticator and the received authenticator do not match. The authentication result is supplied to the user authenticating part 20 in a step S167, as a response with respect to the external authentication request. The process returns to the step S101 if the authentication result indicates that the authentication failed. On the other hand, the process advances to a step S168 if the authentication result indicates that the authentication is successful.

If the authentication using the authentication key is successful, the user authenticating part 20 generates and supplies a random number to the IC card 15 in the step S168, and an authenticator is generated by carrying out an operation with respect to the random number using the authentication key in a step S169. The generated authenticator is supplied to the user authenticating part 20 in a step S170. An authenticator which is generated by carrying out an operation with respect to the random number generated in the step S168 using the registered authentication key is collated with the authenticator received from the IC card 15. The authentication is successful if the collated authenticators match, and the authentication fails if the collated authenticators do not match. The process returns to the step S101 if the authentication fails. On the other hand, if the authentication is successful, the process advances to the step S141 shown in FIG. 15, the illustration of which is omitted in FIG. 17.

Therefore, the authentication of the maintenance person 1 by the IC card 15 is carried out by the steps S132 through S137. The authentication of the equipment 100 by the IC card 15 of the maintenance person 1 is carried out by the steps S161 through S167. The authentication of the IC card 15 of the maintenance person 1 by the equipment 100 is carried out by the steps S168 through S170. The sequence in which the steps S132 through S137, the steps S161 trough S167, and the steps S168 through S170 are carried out is not limited to that shown in FIG. 17.

2.5 Maintenance Procedure

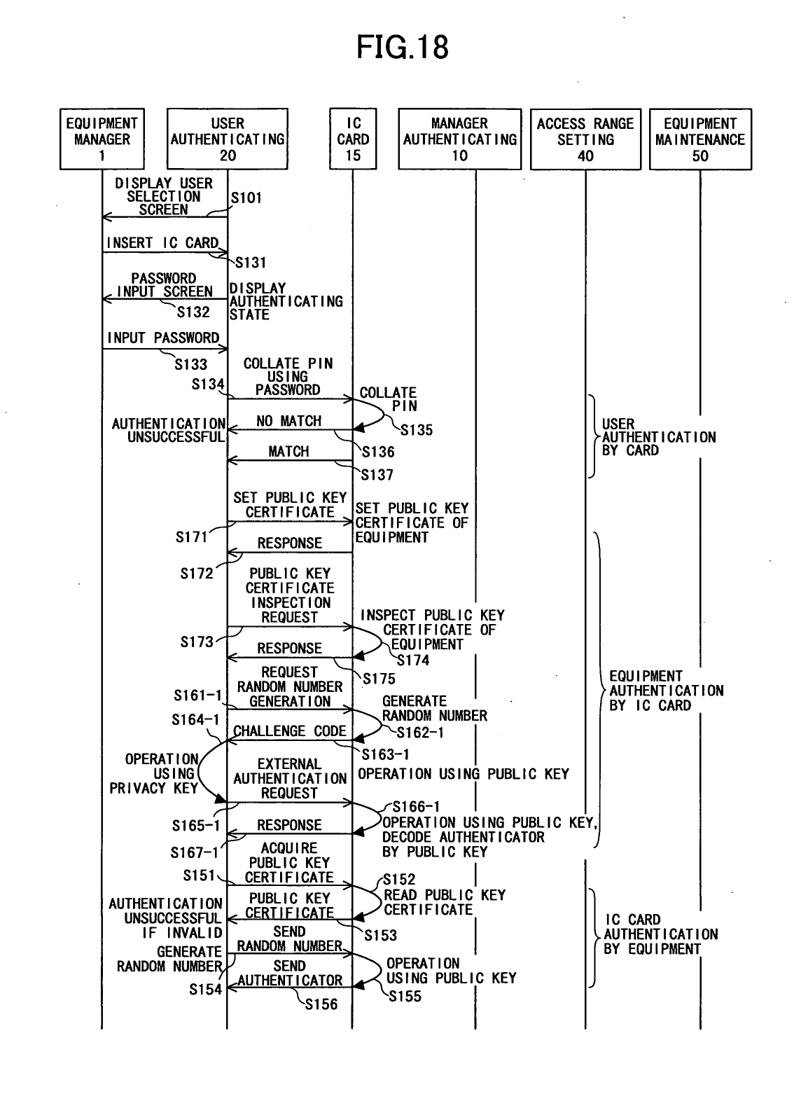

FIG. 18 is a flow chart for explaining another embodiment of the maintenance procedure. In FIG. 18, those steps which are essentially the same as those corresponding steps in FIGS. 15 through 17 are designated by the same reference numerals, and a description thereof will be omitted. In this case, it is assumed for the sake of convenience that the IC card 15 for authenticating the maintenance person 1 is issued by the equipment managing apparatus 200 of the maintenance service provider, and that the maintenance person 1 is authenticated by using the issued IC card 15 in the maintenance target equipment 100. In addition, it is assumed for the sake of convenience that the user authenticating part 20 shown in FIG. 1 is provided with an IC card reader and writer (not shown) having a known structure. Hence, it is possible to authenticate the maintenance person 1 by reading the password (PIN: Personal Identification Number information) and a public key certificate which are stored in the IC card 15 by the IC card writer and reader to be collated with the registered authentication information and public key certificate. The maintenance person 1 for performing the maintenance of the equipment 100 goes to the equipment setup site where the equipment 100 is set up, and performs the maintenance after being authenticated by the equipment 100 within the permitted maintenance range. Of course, an IC card may be issued similarly with respect to the manager 2.

In FIG. 18, after the step S137, the user authenticating part 20 makes a public key certificate set request and sets a public key certificate of the equipment 100 which is registered in advance into the IC card 15, in a step S171. A response indicating whether or not the setting of the public key certificate was successful is supplied tom the IC card 15 to the user authenticating part 20 in a step S172, and the process returns to the step S101 if the setting of the public key certificate fails. On the other hand, if the setting of the public key certificate is successful, the maintenance person 1 possessing the IC card 15 which is set with the public key certificate of the equipment 100 can thereafter perform the maintenance of the equipment 100, and the process advances to a step S173. The user authenticating part 20 makes a public key certificate inspection request which requests inspection of the public key certificate of the equipment 100, with respect to the IC card 15, in the step S173. The public key certificate set in the IC card 15 and the public key certificate supplied from the user authenticating part 20 are collated in a step S174, so as to inspect the public key certificate which is set in the IC card 15. A response indicating the inspection result is supplied from the IC card 15 to the user authenticating part 20 in a step S175. In this case, the public key certificate of the equipment 100 is set in the IC card 15, and thus, the collated public key certificates match and the inspection is successful, so that the process advances to a step S161-1. The process returns to the step S101 if the collated public key certificates do not match and the inspection fails.

The user authenticating part 20 makes a random number generation request with respect to the IC card 15 in the step S161-1, and a random number is generated in a step S162-1. The generate random number is supplied from the IC card 15 to the user authenticating part 20 as a challenge code, in a step S163-1. The user authenticating part 20 generates an authenticator by carrying out an operation with respect to the challenge code using a privacy key which is registered in advance within the equipment 100, in a step S164-1. Then, the user authenticating part 20 makes an external authentication request with respect to the IC card 15 in a step S165-1. An authenticator is generated by carrying out an operation with respect to the random number generated in the step S162-1, using the public key stored in the IC card 15, in a step S166-1. The generated authenticator is collated with the authenticator supplied from the user authenticating part 20, and the authentication is successful if the collated authenticators match and the authentication fails if the collated authenticators do not match. An authentication result is supplied from the IC card 15 to the user authenticating part 20 as a response with respect to the external authentication request, in a step S167-1. The process returns to the step S101 if the authentication result indicates that the authentication failed. On the other hand, if the authentication result indicates that the authentication was successful, the steps S151 through S156 are carried out, and the process thereafter advances to the step S141 shown in FIG. 15, the illustration of which is omitted in FIG. 18.

Therefore, the maintenance person 1 is authenticated by the IC card 15 in the steps S132 through S137. The equipment 100 is authenticated by the IC card 15 of the maintenance person 1 in the steps S171 through S175 and S161-1 through S167-1. In addition, the IC card 15 of the maintenance person 1 is authenticated by the equipment 100 in the steps S151 through S156. The sequence in which the steps S132 through S137, the steps S171 through S175 and S161-1 trough S167-1, and the steps S151 through S156 are carried out is not limited to that shown in FIG. 18.

In the maintenance procedures described above, the various screens are displayed on the display part of the maintenance target equipment 100. However, the various screens may be displayed on a display part of the operating terminal 300 which is operated by the manager 2.

3.1: Changing Maintenance Range

When changing or adding the maintenance range, it is possible to apply the second and third embodiments to the system shown in FIG. 10.

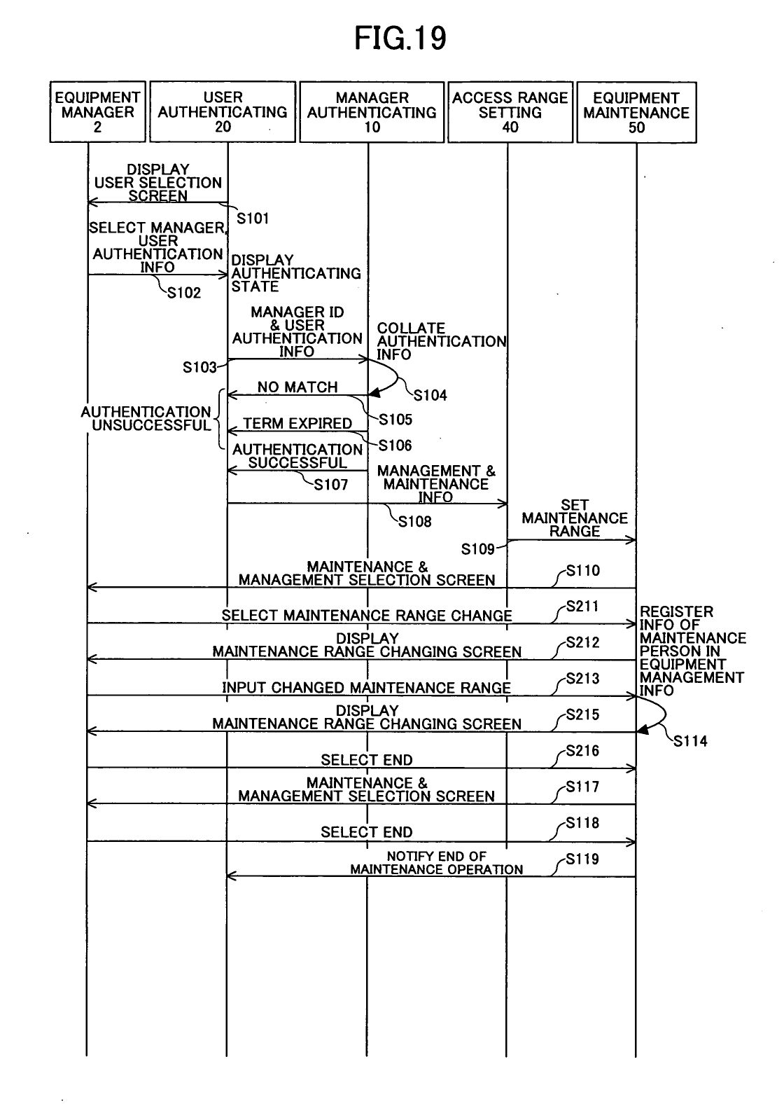

A description will be given of a case where the portion of the maintenance target equipment 100 which actually requires maintenance exceeds the maintenance range and the maintenance range is temporarily changed from the equipment 100 to enable the required maintenance, by referring to FIG. 19. FIG. 19 is a flow chart for explaining an embodiment of a maintenance range changing procedure for the case where the maintenance range is changed from the maintenance target equipment 100. In FIG. 19, it is assumed for the sake of convenience that the manager authenticating part 10, the user authenticating part 20, the access range setting part 40 and the equipment maintenance part 50 are provided within the maintenance target equipment 100, and that the maintenance target equipment 100 is provided with an input part and a display part (both not shown). The input part and the display part may be formed by a touch panel which integrally includes the input part and the display part. In FIG. 19, those steps which are essentially the same as those corresponding steps in FIG. 11 are designated by the same reference numerals, and a description thereof will be omitted.

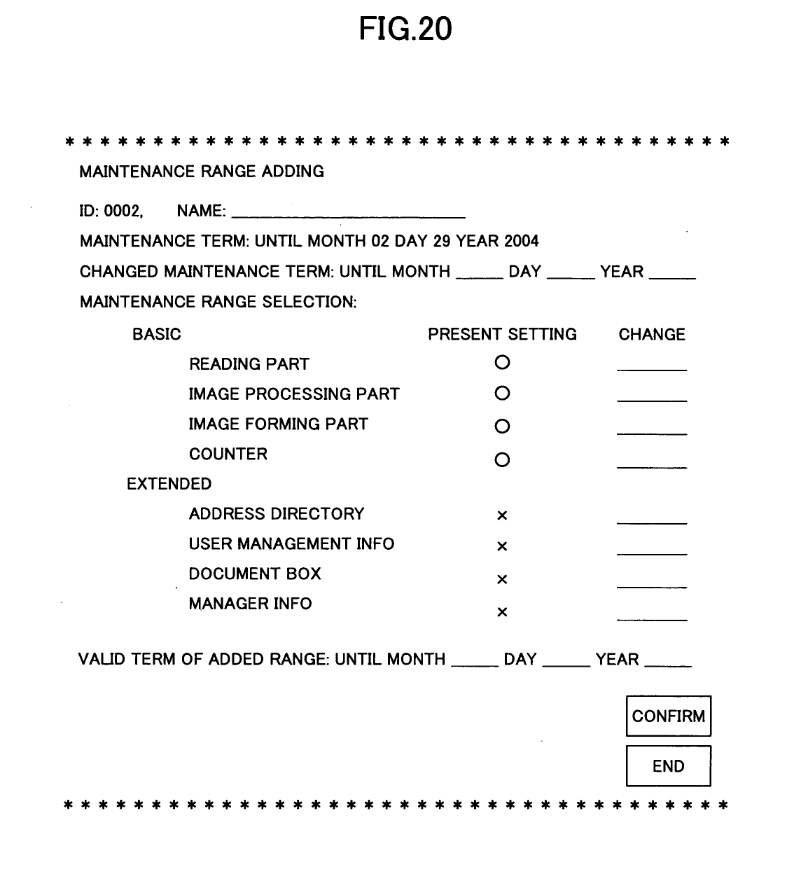

In FIG. 19, after the step S110, the manager 2 selects a maintenance range change from the input part with respect to the equipment maintenance part 50, in a step S211. In response to the selection of the maintenance range change, the equipment maintenance part 50 displays a maintenance range changing screen shown in FIG. 20 in a step S212.

FIG. 20 is a diagram showing the maintenance range changing screen which is displayed on the display part of the equipment 100. As shown in FIG. 20, the maintenance range changing screen includes the ID of the maintenance person, the name of the maintenance person, the maintenance term, the changed maintenance term, the maintenance range selection and the additional range valid term. Since FIG. 20 shows the maintenance range changing screen for the case where the maintenance target equipment 100 is the digital copying apparatus 100-2, the maintenance range selection includes the basic selection and the extended selection. The reading part and the like may be selected by the basic selection, and the address directory and the like may be selected by the extended selection. Maintenance range selection columns for the basic and extended selections are used to display the present setting and to input the setting after the changing of the maintenance range.

When the manager 2 inputs the changed maintenance term, the maintenance range and the like from the input part while monitoring the maintenance range changing screen shown in FIG. 20 and selects a confirm button in a step S213, the input information is supplied to the equipment maintenance part 50. The equipment maintenance part 50 registers the information of the maintenance person in the equipment management information managed by the equipment managing part 60, in a step S214. In addition, the equipment maintenance part 50 again displays the maintenance range changing screen shown in FIG. 20 on the display part, in a step S215. When the manager 2 selects an end button on the maintenance range changing screen in a step S216, the end of the maintenance range change is notified to the equipment maintenance part 50. In response to the end notification of the maintenance range change, the equipment maintenance part 50 displays the maintenance and management selection screen on the display part in the step S117. When the manager 2 selects the end button on the maintenance and management selection screen in the step S118, the end notification of the maintenance and management selection is notified to the equipment maintenance part 50. In response to the end notification of the maintenance and management selection, the equipment maintenance part 50 notifies an end of the maintenance range setting procedure to the user authenticating part 20, in the step S119.

In the case where the maintenance person registration is not included in the maintenance range, the maintenance range cannot be changed, and the steps S110, S211 through S216 and S117 through S119 are not carried out.

3.2: Maintenance Range Change

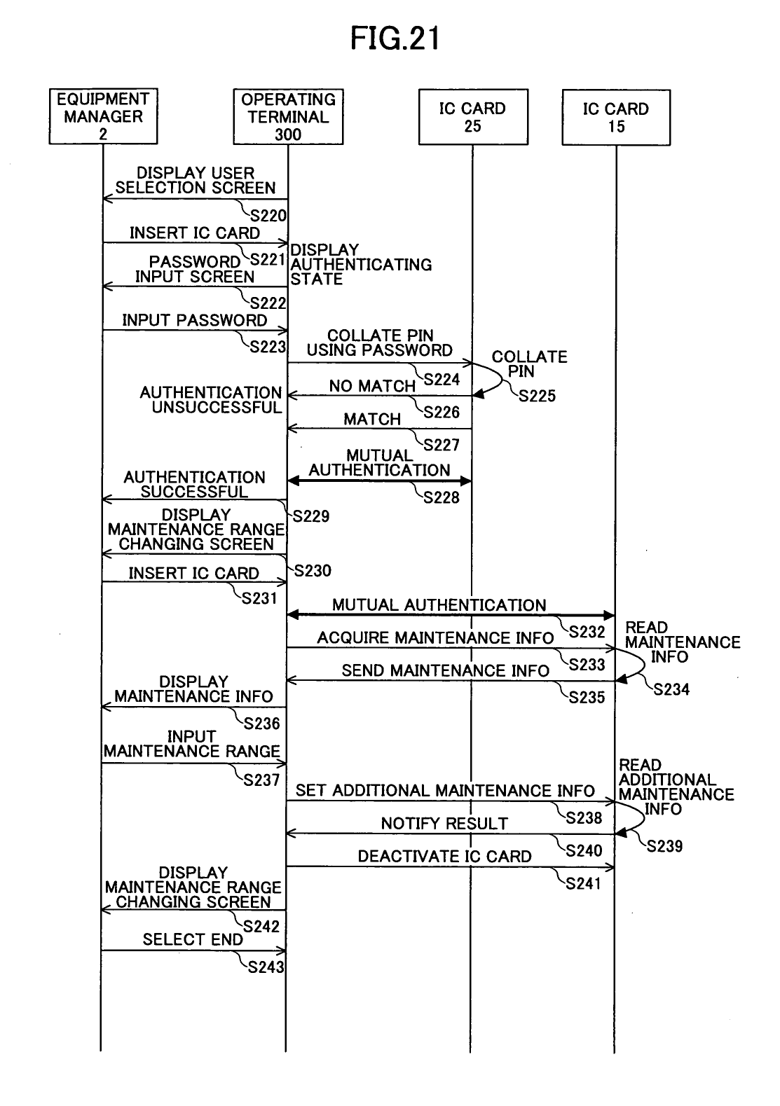

A description will be given of a case where the portion of the maintenance target equipment 100 which actually requires maintenance exceeds the maintenance range and the maintenance range is temporarily changed from the operating terminal 300 shown in FIG. 10 to enable the required maintenance, by referring to FIG. 21. FIG. 21 is a flow chart for explaining an embodiment of the maintenance range changing procedure for the case where the maintenance range is changed from the operating terminal 300. In this case, the operating terminal 300 functions as an equipment managing apparatus. It is assumed for the sake of convenience that the IC card 15 for authenticating the maintenance person 1 and an IC card 25 for authenticating the manager 2 are issued. For example, the IC card 15 is issued from the equipment managing apparatus 200, and the IC card 25 is issued from the operating terminal 300. In addition, in the following description, it is assumed for the sake of convenience that the IC card 15 is read by an IC card reader and writer (not shown) of the maintenance target equipment 100 and the IC card 25 is read by an IC card reader and writer (not shown) of the operating terminal 300.

In FIG. 21, steps S220 through S227 are basically the same as steps S101 and S131 through S136 shown in FIG. 15, except that the IC card 25 is inserted in the step S220 and the process is between the IC card 25 and the operating terminal 300 and the display part thereof, and a description thereof will be omitted. In addition, a mutual authentication between the operating terminal 300 and the IC card 25 in a step S228 may be carried out similarly to the mutual authentication between the equipment 100 and the IC card 15 in FIG. 16, and a description thereof will be omitted. The process returns to the step S220 if the mutual authentication fails, and the process advances to a step S229 if the mutual authentication is successful.

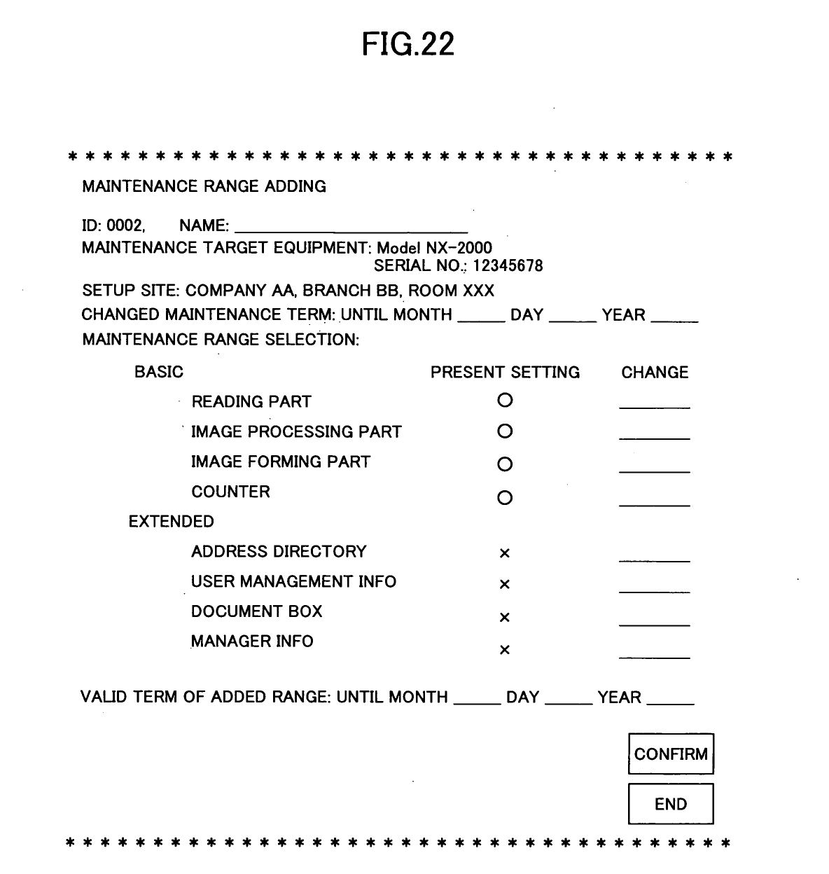

The operating terminal 300 notifies the manager 2 that the mutual authentication was successful, by displaying a message or the like on the display part of the operating terminal 300 in the step S229. The operating terminal 300 displays a maintenance range changing screen shown in FIG. 22 on the display part thereof in a step S230. The manager 2 specifies the maintenance target equipment 100 on the maintenance range changing screen and inserts the IC card 15 in the maintenance target equipment 100 in the step S230.

FIG. 22 is a diagram showing the maintenance range changing screen which is displayed on the display part of the operating terminal 300. As shown in FIG. 22, the maintenance range changing screen includes the ID of the maintenance person, the name of the maintenance person, the maintenance target equipment, the setup site (or location), the maintenance term, the changed maintenance term, the maintenance range selection and the additional range valid term. Since FIG. 22 shows the maintenance range changing screen for the case where the maintenance target equipment 100 is the digital copying apparatus 100-2, the maintenance range selection includes the basic selection and the extended selection. The reading part and the like may be selected by the basic selection, and the address directory and the like may be selected by the extended selection. Maintenance range selection columns for the basic and extended selections are used to display the present setting and to input the setting after the changing of the maintenance range.

A mutual authentication between the operating terminal 300 and the IC card 15 in a step S232 may be carried out similarly to the mutual authentication between the equipment 100 and the IC card 15 in FIG. 16, and a description thereof will be omitted. The process returns to the step S220 if the mutual authentication fails, and the process advances to a step S233 if the mutual authentication is successful. The operating terminal 300 requests the maintenance information with respect to the IC card 15 in the step S233. The maintenance information is read from the IC card 15 in a step S234, and the read maintenance information is supplied to the operating terminal 300 in a step S235. The operating terminal 300 displays the maintenance information on the maintenance range changing screen described above in a step S236. When the manager 2 inputs a change in the maintenance range on the maintenance range changing screen and selects the confirm button in a step S237, the operating terminal 300 supplies maintenance range changing information to the IC card 15 in a step S238, and the maintenance range changing information is written into the IC card 15 in a step S239. A result of writing the maintenance range changing information to the IC card 15 is notified to the operating terminal 300 in a step S240. If the maintenance term of the IC card 15 is expired, the operating terminal 300 deletes the maintenance range changing information written in the IC card 15 to deactivate the IC card 15 in a step S241. The operating terminal 300 again displays the maintenance range changing screen shown in FIG. 22 on the display part of the operating terminal 300 in a step S242. When the manager 2 selects the end button on the maintenance range changing screen in a step S243, the end of the maintenance range change is notified to the operating terminal 300.

3.3: Adding Maintenance Range

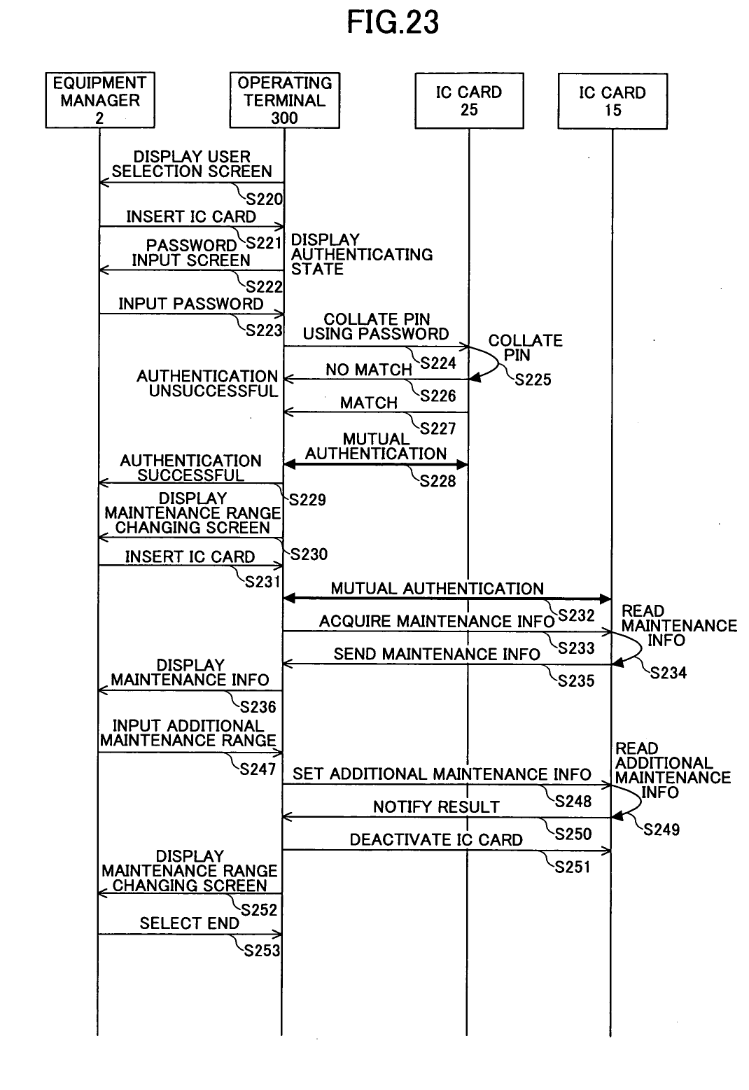

A description will be given of a case where the portion of the maintenance target equipment 100 which actually requires maintenance exceeds the maintenance range and a maintenance range is temporarily added from the operating terminal 300 to enable the required maintenance, by referring to FIG. 23. FIG. 23 is a flow chart for explaining an embodiment of a maintenance range adding procedure for the case where the maintenance range is added from the operating terminal 300. In this case, the operating terminal 300 functions as an equipment managing apparatus. It is assumed for the sake of convenience that the IC card 15 for authenticating the maintenance person 1 and an IC card 25 for authenticating the manager 2 are issued. For example, the IC card 15 is issued from the equipment managing apparatus 200, and the IC card 25 is issued from the operating terminal 300. In addition, in the following description, it is assumed for the sake of convenience that the IC card 15 is read by an IC card reader and writer (not shown) of the maintenance target equipment 100 and the IC card 25 is read by an IC card reader and writer (not shown) of the operating terminal 300. In FIG. 23, those steps which are essentially the same as those corresponding steps in FIG. 21 are designated by the same reference numerals, and a description thereof will be omitted.

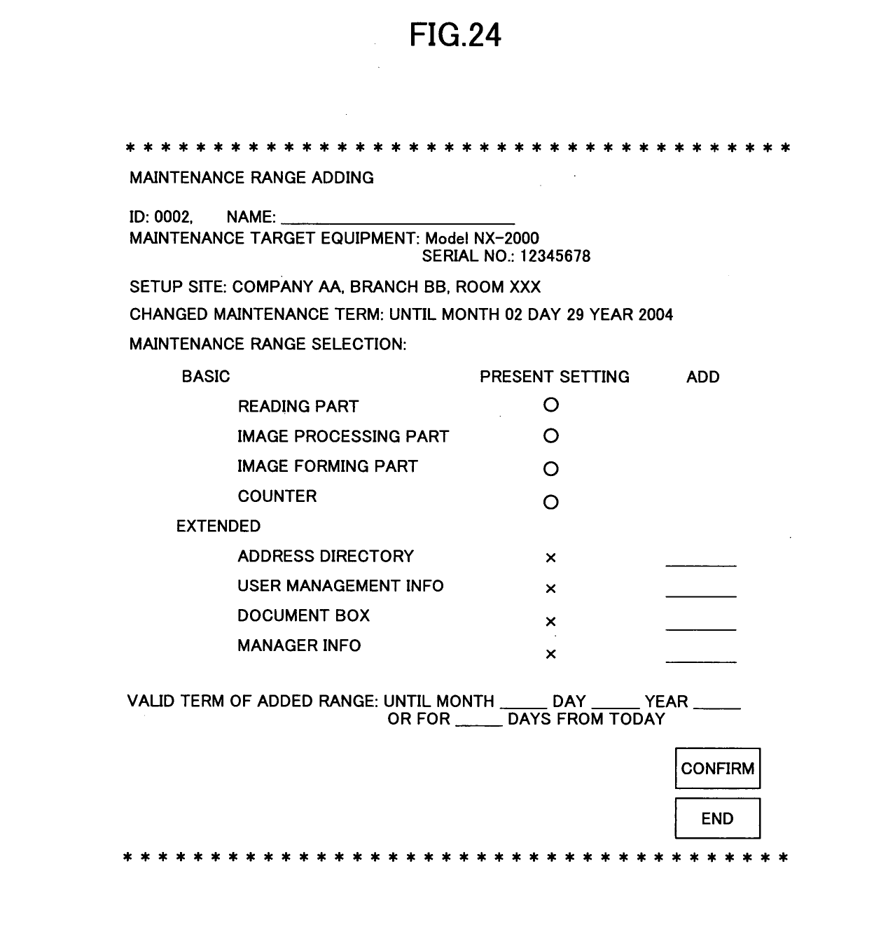

In FIG. 23, after the step S236, when the manager 2 inputs an addition of a maintenance range on a maintenance range adding screen shown in FIG. 24 which is displayed on the display part of the operating terminal 300 and selects a confirm button in a step S237, the operating terminal 300 supplies maintenance range adding information to the IC card 15 in a step S248. The maintenance range adding information is written into the IC card 15 in a step S249. The addition of the maintenance range includes addition of a maintenance target equipment, addition of a maintenance range, a valid term of added maintenance range (added range valid term) and the like.

FIG. 24 is a diagram showing the maintenance range adding screen which is displayed on the display part of the operating terminal 300. As shown in FIG. 24, the maintenance range adding screen includes the ID of the maintenance person, the name of the maintenance person, the maintenance target equipment, the setup site (or location), the maintenance term, the maintenance range selection and the additional range valid term. Since FIG. 24 shows the maintenance range adding screen for the case where the maintenance target equipment 100 is the digital copying apparatus 100-2, the maintenance range selection includes the basic selection and the extended selection. The reading part and the like may be selected by the basic selection, and the address directory and the like may be selected by the extended selection. Maintenance range selection columns for the basic and extended selections are used to display the present setting and to input the setting after the changing of the maintenance range.

A result of the writing of the maintenance range adding information into the IC card 15 is notified to the operating terminal 300 in a step S250. If the maintenance term of the IC card 15 is expired, the operating terminal 300 deletes the maintenance range adding information written in the IC card 15 to deactivate the IC card 15 in a step S251. The operating terminal 300 again displays the maintenance range adding screen shown in FIG. 24 on the display part of the operating terminal 300 in a step S252. When the manager 2 selects the end button on the maintenance range adding screen in a step S253, the end of the maintenance range adding is notified to the operating terminal 300.

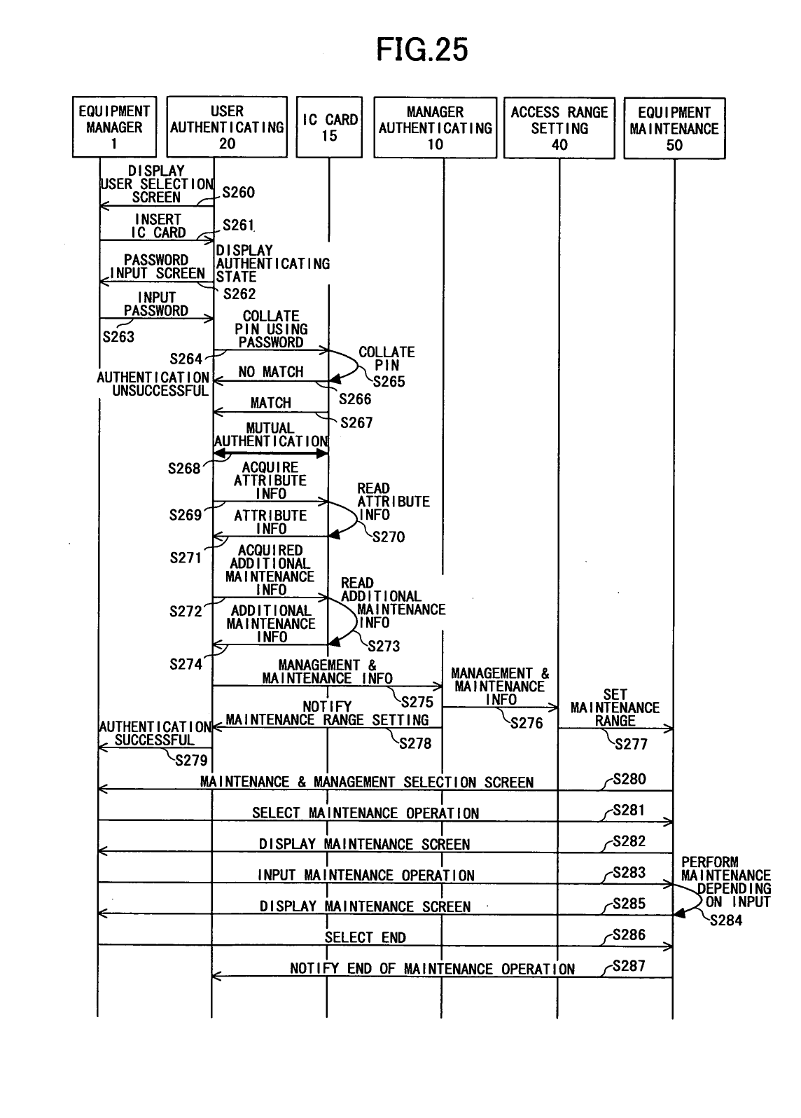

FIG. 25 is a flow chart for explaining an embodiment of the maintenance procedure after the maintenance range is added as described above. In FIG. 25, steps S260 through S266 are essentially the same as the steps S101 and S131 through S136 shown in FIG. 15, and a description thereof will be omitted.

A mutual authentication between the equipment 100 and the IC card 15 in a step S268 may be carried out similarly to the mutual authentication between the equipment 100 and the IC card 15 in FIG. 16, and a description thereof will be omitted. The process returns to the step S260 if the mutual authentication fails, and the process advances to a step S269 if the mutual authentication is successful.

The user authenticating part 20 makes access to the IC card 15 in the step S269, so as to read the permitted maintenance information from the IC card 15, as the attribute information of the authenticated (permitted) maintenance person 1, in a step S270. The read maintenance information includes the maintenance range and the maintenance term. The maintenance information read from the IC card 15 is supplied to the user authenticating part 20 in a step S271. Accordingly, the steps S269 through S271 correspond to the steps S138 through S140 shown in FIG. 15. The user authenticating part 20 makes access to the IC card 15 in a step S272, and reads the additional maintenance information from the IC card 15 in a step S273. The read additional maintenance information includes the maintenance range and the maintenance period. The additional maintenance information read from the IC card 15 is supplied to the user authenticating part 20 in a step S274.

Steps S275 through S287 which are carried out thereafter are similar to the steps S141, S143 through S145, S110 and S121 through S127 shown in FIG. 15, and a description thereof will be omitted.

4.1: Maintenance Permit Issuance

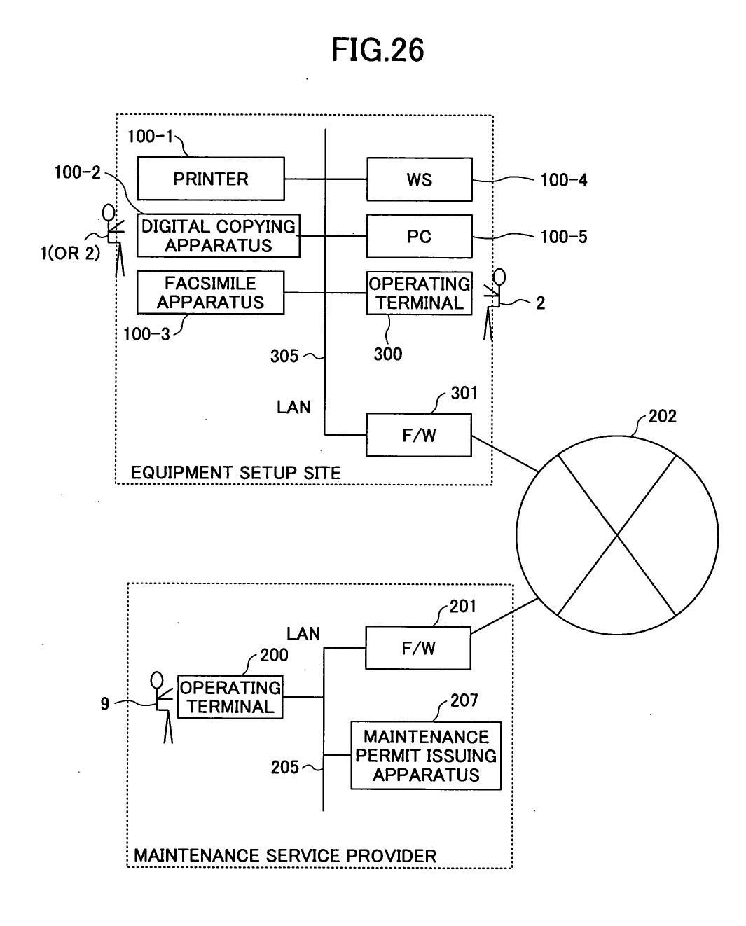

FIG. 26 is a system block diagram showing a system which enables changing of the maintenance range by issuing a maintenance permit. In FIG. 26, those parts which are the same as those corresponding parts in FIG. 10 are designated by the same reference numerals, and a description thereof will be omitted. In the system shown in FIG. 26, a maintenance permit issuing apparatus 207 is provided in the maintenance service provider.

In the case where the IC card 15 for authenticating the maintenance person 1 and the IC card 25 for authenticating the manager 2 are issued, a maintenance permit which enables temporary changing of the maintenance range may be issued from the maintenance service provider so as to temporarily change the maintenance range of the maintenance person 1.

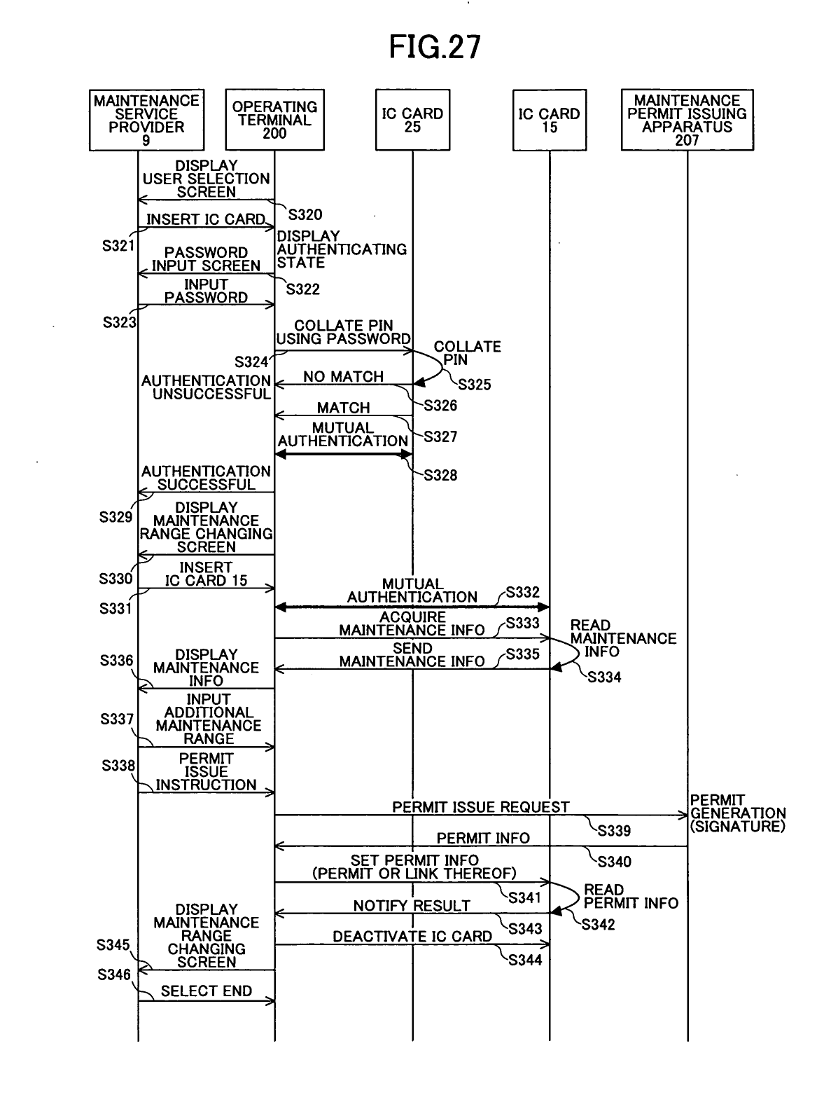

A description will be given of the case where the maintenance permit which enables temporary changing of the maintenance range is issued from the maintenance service provider, by referring to FIG. 27. FIG. 27 is a flow chart for explaining an embodiment of a maintenance permit issuing procedure for issuing the maintenance permit from the maintenance service provider. In FIG. 27, it is assumed for the sake of convenience that the IC card 15 of the maintenance person 1 is inserted into the IC card reader and writer of the maintenance target equipment 100 and the IC card 25 of the manager 25 is inserted into the IC card read and writer of the operating terminal 300.

In FIG. 27, steps S320 through S336 are similar to the steps S220 through S236 shown in FIG. 21, except that the equipment managing apparatus 200 and a maintenance-attending person 9 of the maintenance service provider are related to the process, and a description thereof will be omitted. The equipment managing apparatus 200 displays the maintenance information on a maintenance range adding screen similar to the maintenance range adding screen shown in FIG. 24, in a step S336. When the maintenance-attending person 9 inputs the addition of the maintenance range on the maintenance range adding screen and selects a confirm button in a step S337, a maintenance permit issue instruction is supplied to the maintenance permit issuing apparatus 207 in a step S338. The maintenance permit issuing apparatus 200 supplies a maintenance permit issue request to the maintenance permit issuing apparatus 207 in a step S339. The maintenance permit issue request includes the maintenance range adding information. Hence, the maintenance permit issuing apparatus 207 issues a maintenance permit and supplies permit information to the equipment managing apparatus 200 in a step S340. The permit information includes the maintenance permit including the maintenance range adding information and/or link information of the maintenance permit. Communication between the equipment managing apparatus 200 and the maintenance permit issuing apparatus 207 may be made by carrying out a mutual authentication and/or enciphered communication, so as to improve the security. The equipment managing apparatus 200 supplies the permit information to the IC card 15 in a step S341, and the permit information is written into the IC card in a step S342. A result of writing the permit information into the IC card 15 is notified to the equipment managing apparatus 200 in a step S343. If the maintenance term of the IC card 15 is expired, the equipment managing apparatus 200 deletes the maintenance range adding information written in the IC card 15 and deactivates the IC card 15 in a step S344. The equipment managing apparatus 200 again displays the maintenance range adding screen on the display part of the equipment managing apparatus 200 in a step S345. When the maintenance-attending person 9 selects the end button on the maintenance range adding screen, the end of the maintenance range adding is notified to the equipment managing apparatus 200 in a step S346.

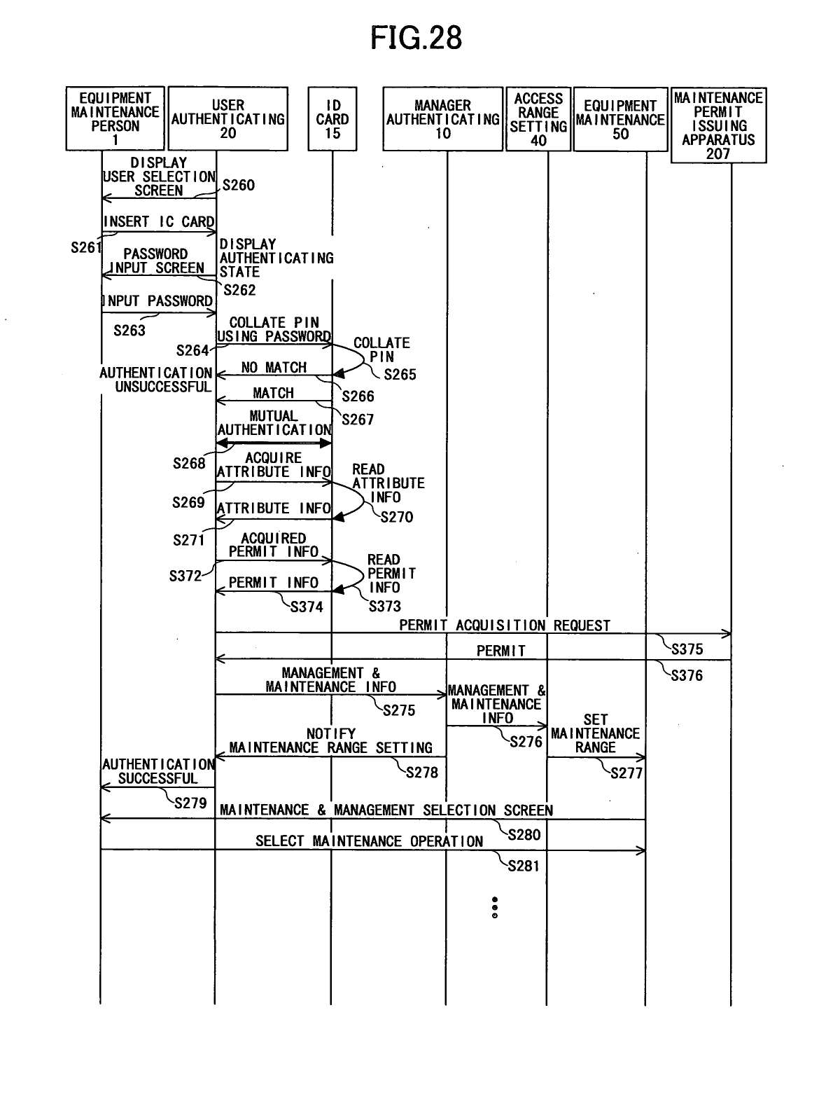

FIG. 28 is a flow chart for explaining an embodiment of the maintenance procedure after the maintenance permit described above is issued. In FIG. 28, those steps which are essentially the same as those corresponding steps in FIG. 25 are designated by the same reference numerals, and a description thereof will be omitted.

In FIG. 28, after the step S269, the user authenticating part 20 supplies a permit information acquisition request to the IC card 15 in a step S372, and the permit information is read from the IC card 15 in a step S373. The read permit information is supplied to the user authenticating part 20 in a step S374. In this case, it is assumed for the sake of convenience that the permit information includes the link information of the maintenance permit, and does not include the maintenance permit itself. Hence, the user authenticating part 20 supplies a permit acquisition request to the maintenance permit issuing apparatus 207 based on the link information within the permit information, in a step S375. The maintenance permit issuing apparatus 207 which receives the permit acquisition request supplies the maintenance permit to the user authenticating part 20 in a step S376. The communication between the maintenance permit issuing apparatus 207 and the user authenticating part 20, that is, the maintenance target equipment 100, may be made by carrying out a mutual authentication and/or enciphered communication, so as to improve the security. Hence, the process of the step S275 and subsequent steps is carried out using the maintenance range adding information included in the maintenance permit. In FIG. 28, the illustration of the step S282 and the subsequent steps is omitted.

4.2: Maintenance Permit Issuance

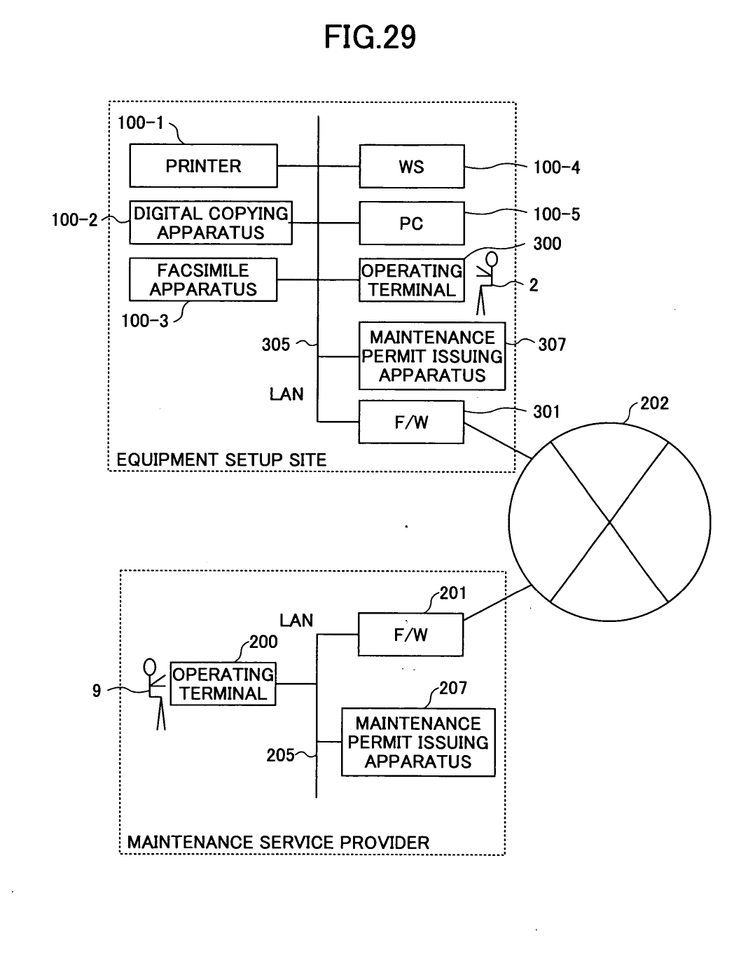

FIG. 29 is a system block diagram showing a system which enables changing of the maintenance range by issuing a maintenance permit. In FIG. 29, those parts which are the same as those corresponding parts in FIG. 26 are designated by the same reference numerals, and a description thereof will be omitted. In the system shown in FIG. 29, a maintenance permit issuing apparatus 307 is provided in the equipment setup site. In this case, the maintenance permit issuing apparatus 207 may be omitted. Furthermore, the fourth embodiment may be applied in the case of a system provided with both the maintenance permit issuing apparatuses 207 and 307.

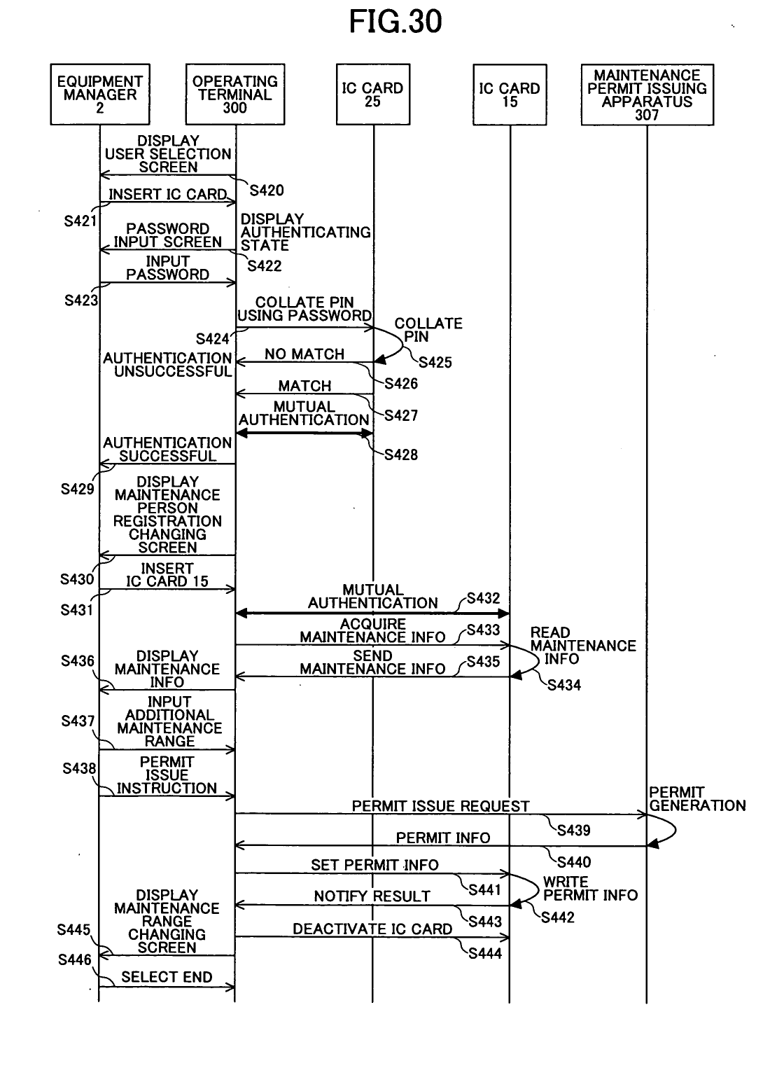

A description will be given of a case where the maintenance permit which enables the temporary changing of the maintenance range is issued at the equipment setup site, by referring to FIG. 30. FIG. 30 is a flow chart for explaining another embodiment of the maintenance permit issuing procedure for the case where the maintenance permit is issued at the equipment setup site. In FIG. 30, it is assumed for the sake of convenience that the IC card 15 of the maintenance person 1 is inserted into the IC card reader and writer of the maintenance target equipment 100, and the IC card 25 of the manager 2 is inserted into the IC card reader and writer of the operating terminal 300.

In FIG. 30, steps S420 through 446 are similar to the steps S320 through S346 shown in FIG. 27, except that the maintenance permit issuing apparatus 307 at the equipment setup site is related to the process, and a description thereof will be omitted. In the step S440, the communication between the operating terminal 300 and the maintenance permit issuing apparatus 307 may be made by carrying out a mutual authentication and/or enciphered communication, so as to improve the security.

4.3: Maintenance Permit Issuance

Next, a description will be given of the maintenance permit issuing procedure and the maintenance procedure for a case where the remote maintenance is carried out as in the fourth embodiment described above. As described above, FIG. 29 also shows the system which may be applied with the fourth embodiment.

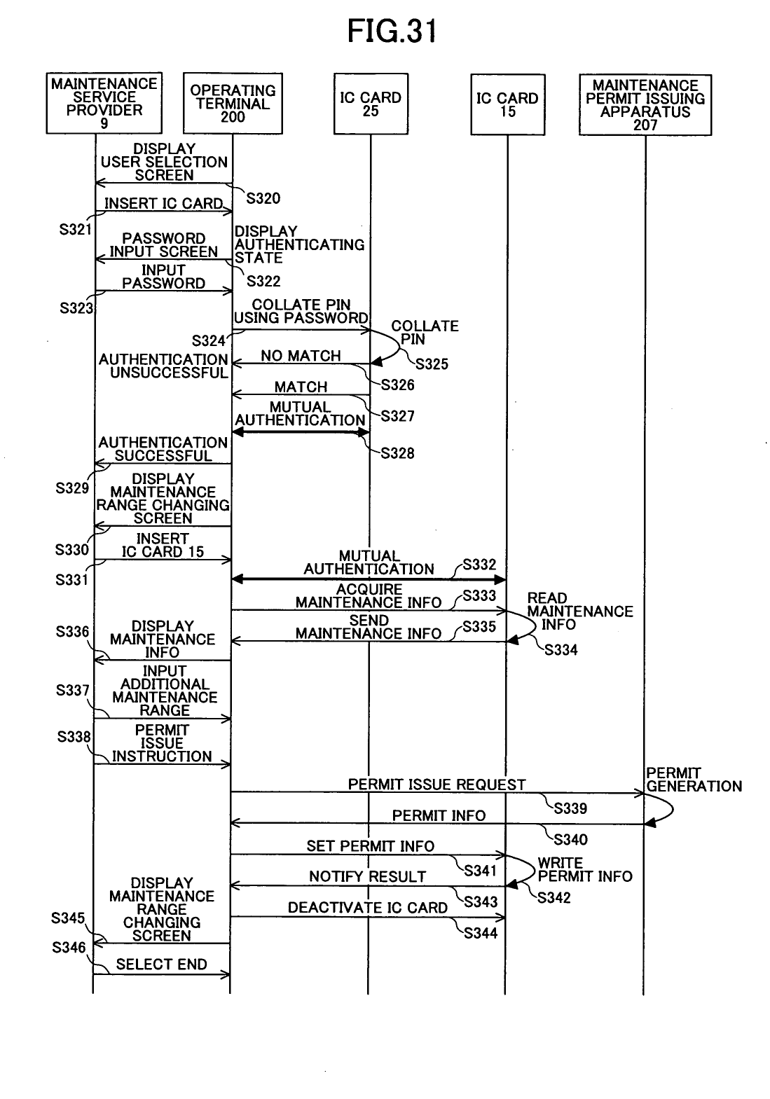

A description will be given of a case where a maintenance permit for remote maintenance (hereinafter simply referred to as a remote maintenance permit), which enables temporary changing of the maintenance range, is issued from the maintenance service provider, by referring to FIG. 31. FIG. 31 is a flow chart for explaining an embodiment of a remote maintenance permit issuing procedure for a case where the remote maintenance permit is issued from the maintenance service provider. In FIG. 31, it is assumed for the sake of convenience that the IC card 15 of the maintenance person 1 is inserted into the IC card reader and writer of the maintenance target equipment 100, and the IC card 25 of the manager 2 is inserted into the IC card reader and writer of the operating terminal 300.

The process shown in FIG. 31 is essentially the same as the process shown in FIG. 27, except that the maintenance permit that is issued is the remote maintenance permit. For this reason, in FIG. 31, those steps which are essentially the same as those corresponding steps in FIG. 27 are designated by the same reference numerals, and a description thereof will be omitted.

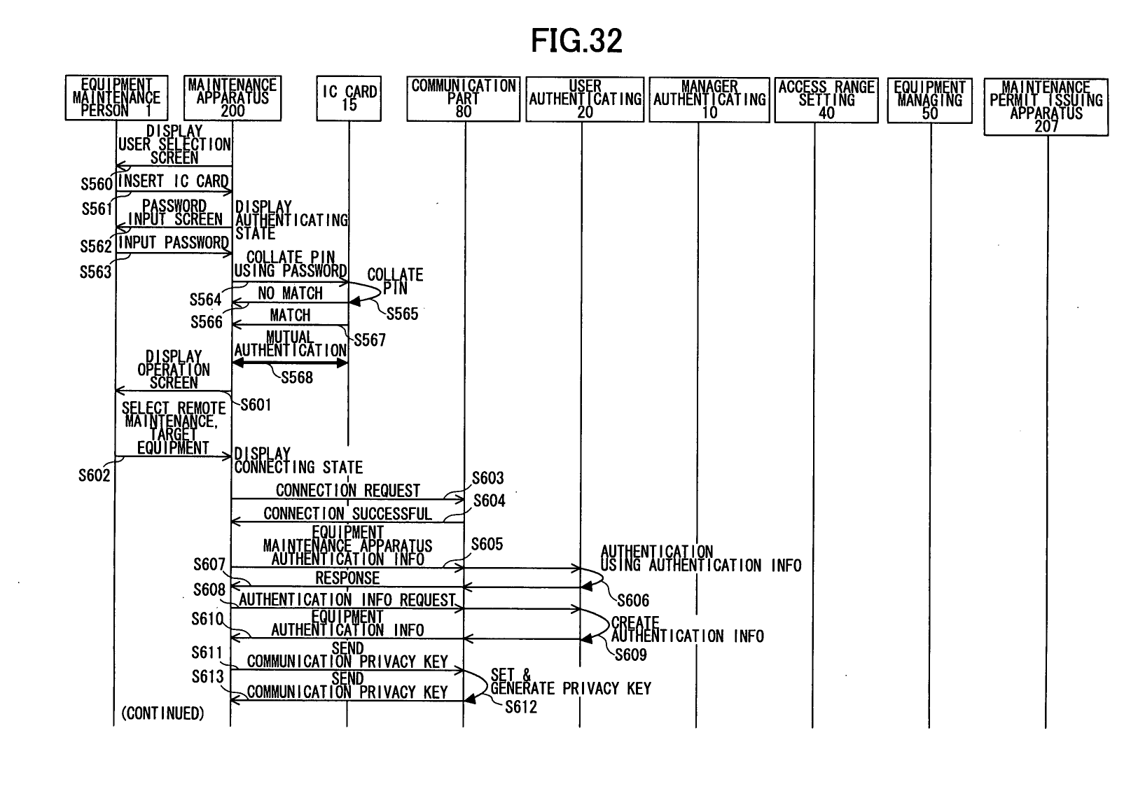

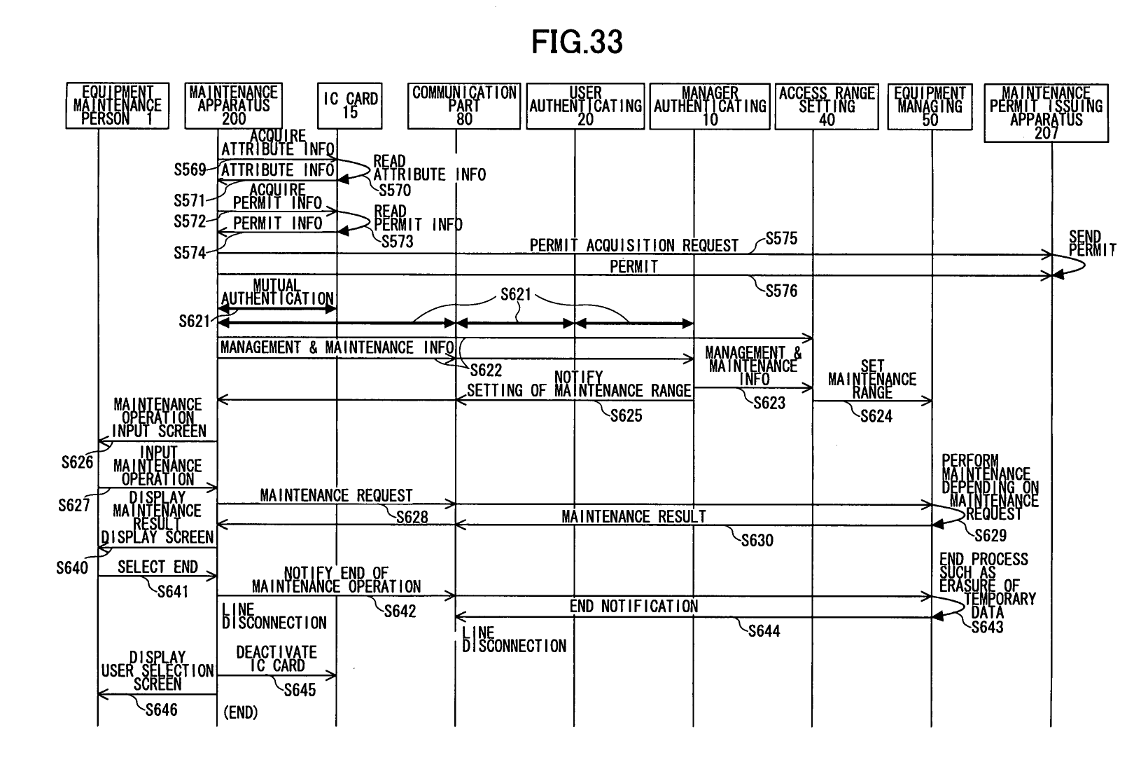

FIGS. 32 and 33 are flow charts for explaining an embodiment of the maintenance procedure after the remote maintenance permit is issued as described above. It is assumed for the sake of convenience that the IC card 15 is inserted into the IC card reader and writer (not shown) of the equipment managing apparatus 200.

In FIG. 32, steps S560 through S568 are essentially the same as the steps S360 through S368 shown in FIG. 28, except that the equipment managing apparatus 200 is related to the process, and a description thereof will be omitted. Similarly, in FIG. 33, steps S569 through S576 are essentially the same as the steps S369 through S376 shown in FIG. 28, except that the equipment managing apparatus 200 is related to the process, and a description thereof will be omitted. Of course, the maintenance-attending person 9 may perform the operation in place of the maintenance person 1.

In FIG. 32, the equipment managing apparatus 200 displays an operation screen on the display part of the equipment managing apparatus 200 in a step S601. The maintenance person 1 selects the equipment 100, which is the target of the remote maintenance, on the operation screen, in a step S602, and thus, the maintenance target equipment 100 is supplied (or notified) to the equipment managing apparatus 200. The equipment managing apparatus 200 displays a message on the display part to indicate a connecting state, and makes a connection request with respect to the communication part 80 of the maintenance target equipment 100, in a step S603. The communication part 80 supplies a response indicating that the connection was successful, in response to the connection request, to the equipment managing apparatus 200 in a step S604. Accordingly, the equipment managing apparatus 200 supplies the authentication information (apparatus authentication information) of the equipment managing apparatus 200 to the user authenticating part 20 of the maintenance target equipment 100, in a step S605. The user authenticating part 20 authenticates the equipment managing apparatus 200 based on the apparatus authentication information supplied from the equipment managing apparatus 200 and an apparatus authentication information which is registered in advance, in a step S606. An authentication result is supplied from the user authenticating part 20 to the equipment managing apparatus 200 in a step S607. If the authentication based on the apparatus authentication information fails, the process returns to the step S560.

On the other hand, if the authentication based on the apparatus authentication information is successful, the equipment managing apparatus 200 makes an equipment authentication information request with respect to the user authenticating part 20 in a step S608. The user authenticating part 20 generates equipment authentication information in response to the equipment authentication information request in a step S609, and supplies the generated equipment authentication information to the equipment managing apparatus 200 in a step S610. The equipment managing apparatus 200 authenticates the equipment 100 based on the equipment authentication information which is registered in advance and the equipment authentication information received from the user authenticating part 20. The process returns to the step S560 if the authentication fails, and the process advances to a step S611 if the authentication is successful. The equipment managing apparatus 200 supplies a privacy key for communication (hereinafter referred to as communication privacy key) to the communication part 80 in the step S611, and the communication part 80 set and generates a privacy key in a step S612. The communication part 80 supplies the generated privacy key to the equipment managing apparatus 200 in a step S613. Therefore, the communication between the equipment managing apparatus 200 and the equipment 100 can be made using the privacy key.

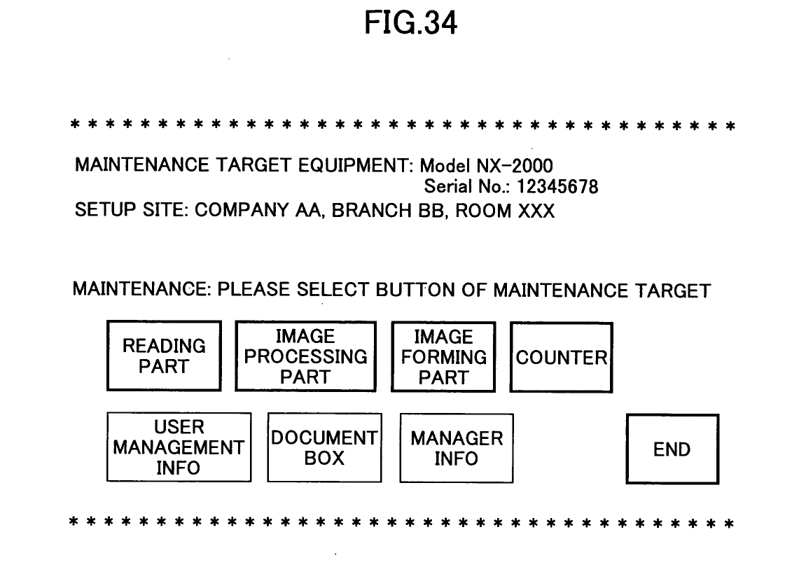

In FIG. 33, after the step S576, the equipment managing apparatus 200 carries out a mutual authentication with the IC card 15 by communicating with the manager authenticating part 10 and the user authenticating part 20 via the communication part 80, in a step S621. The process returns to the step S560 shown in FIG. 32 if the mutual authentication fails. On the other hand, if the mutual authentication is successful, the equipment managing apparatus 200 supplies the management and maintenance information to the access range setting part 40 and the manager authenticating part 10, in a step S622. Hence, the manager authenticating part 10 supplies the management and maintenance information to the access range setting part 40 and sets the management and maintenance range in a step S623. In addition, the access range setting part 40 supplies the maintenance range information to the equipment maintenance part 50 in a step S624. The manager authenticating part 10 makes a maintenance range set notification with respect to the equipment managing apparatus 200 in a step S625. The equipment managing apparatus 200 which receives the maintenance range set notification displays a maintenance operation input screen shown in FIG. 34 on the display part of the equipment managing apparatus 200, in a step S626.

FIG. 34 is a diagram showing the maintenance operation input screen. As shown in FIG. 34, the maintenance operation input screen displays the maintenance target equipment, the setup site (or location), maintenance targets within the maintenance range, and the like. Because FIG. 34 shows the maintenance operation input screen for the case where the maintenance target equipment 100 is the digital copying apparatus 100-2, the maintenance targets within the maintenance range include the reading part, the image processing part, the image forming part and the like.

When the maintenance person 1 selects the maintenance target on the maintenance operation input screen in a step S627, information of the selected maintenance target is supplied to the equipment managing apparatus 200. The equipment managing apparatus 200 supplies a maintenance request with respect to the maintenance target to the equipment maintenance part 50, in a step S628. The equipment maintenance part 50 performs the maintenance of the maintenance target according to the maintenance request, in a step S629. A result of the maintenance that is performed is supplied from the equipment maintenance part 50 to the equipment managing apparatus 200 in a step S630. The equipment managing apparatus 200 displays a maintenance result display screen which indicates the result of the maintenance, on the display part of the equipment managing apparatus 200, in a step S640. When the maintenance person 1 selects an end button on the maintenance result display screen in a step S641, the end of the maintenance operation is notified to the equipment managing apparatus 200. In response to this maintenance operation end notification, the equipment managing apparatus 200 supplies a maintenance operation end notification to the equipment maintenance part 50 in a step S642. The equipment maintenance part 50 carries out an ending process, such as erasing temporary data, in response to the maintenance operation end notification, in a step S643. The equipment maintenance part 50 makes an end notification with respect to the communication part 80 in a step S644. Therefore, the line between the maintenance target equipment 100 and the equipment managing apparatus 200 via the communication part 80 is disconnected.

Thereafter, the equipment managing apparatus 200 deletes the maintenance range changing information which is written into the IC card 15 to deactivate the IC card 15, in a step S645. Further, the equipment managing apparatus 200 displays a user selection screen on the display part of the equipment managing apparatus 200 in a step S646.

4.4: Maintenance Permit Issuance

Next, a description will be given of the maintenance permit issuing procedure and the maintenance procedure for a case where the remote maintenance is carried out as in the fourth embodiment described above. As described above, FIG. 29 also shows the system which may be applied with the fourth embodiment.

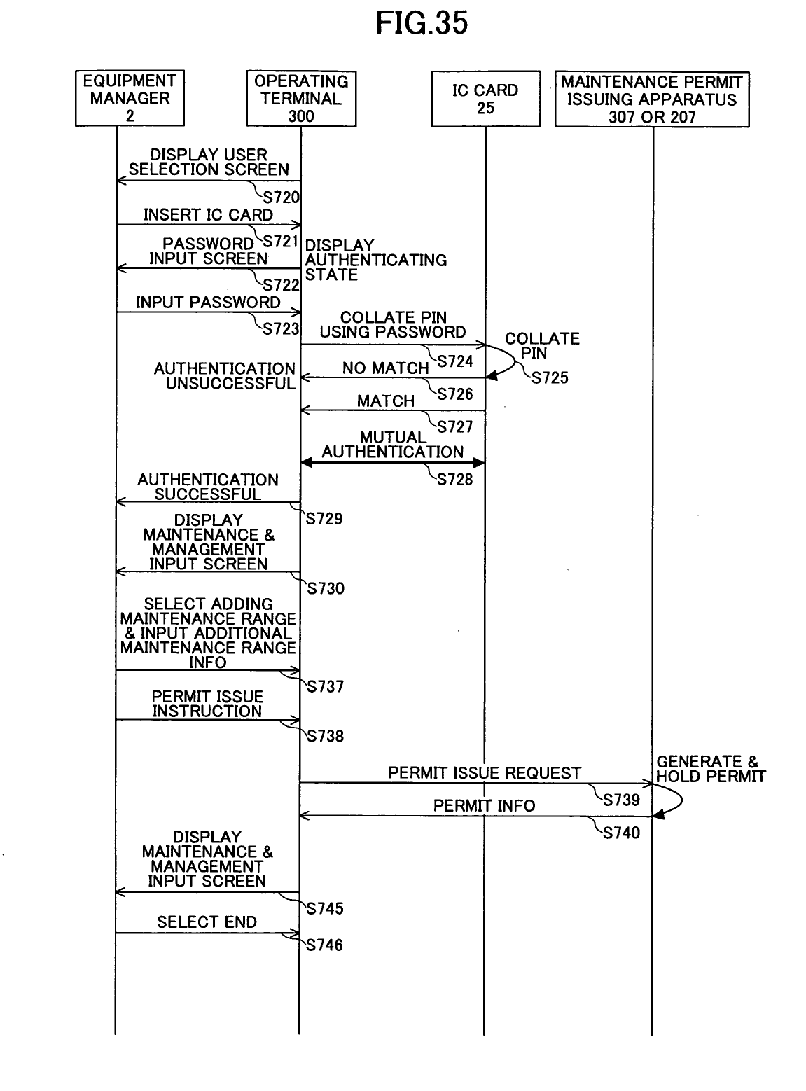

A description will be given of a case where a remote maintenance permit, which enables temporary changing of the maintenance range, is issued at the equipment setup site, by referring to FIG. 35. FIG. 35 is a flow chart for explaining an embodiment of the remote maintenance permit issuing procedure for a case where the remote maintenance permit is issued at the equipment setup site. In FIG. 35, it is assumed for the sake of convenience that the IC card 25 of the manager 2 is inserted into the IC card reader and writer of the operating terminal 300.

The process shown in FIG. 35 is essentially the same as the process shown in FIG. 31, except that the issuance of the remote maintenance permit is requested at the equipment setup site. In other words, the issuance of the remote maintenance permit is requested from the operating terminal 300, and the remote maintenance permit issue request may be made with respect to the maintenance permit issuing apparatus 307 at the equipment setup site or, with respect to the maintenance permit issuing apparatus 207 of the maintenance service provider. For this reason, a description of those steps shown in FIG. 35 which are essentially the same as the corresponding steps in FIG. 31 will be omitted. Steps S720 through S730 shown in FIG. 35 correspond to the steps S320 through S330 shown in FIG. 31, and the steps S737 through S740, S745 and S746 shown in FIG. 35 correspond to the steps S337 through S340, S345 and S346 shown in FIG. 31. In FIG. 35, the steps S730 and S745 display a maintenance and management input screen on the display part, but this maintenance and management input screen may be similar to the maintenance range changing screen and the maintenance range adding screen described above. In addition, the step S737 selects the maintenance range to be added and inputs the additional maintenance range.

The maintenance procedure after the remote maintenance permit is issued as described above may basically be the same as the maintenance procedure shown in FIGS. 32 and 33, and an illustration and description thereof will be omitted. In this case, the maintenance procedure only differs from the maintenance procedure shown in FIGS. 32 and 33, in that the remote maintenance permit is acquired from the maintenance permit issuing apparatus 307 at the equipment setup site or, from the maintenance permit issuing apparatus 207 of the maintenance service provider.

In each of the embodiments described heretofore, the mutual authentication between the equipments may be realized by the combination of the equipment authentication by the IC card and the IC card authentication by the equipment, as described hereunder.

5.1: Mutual Authentication Between Equipments

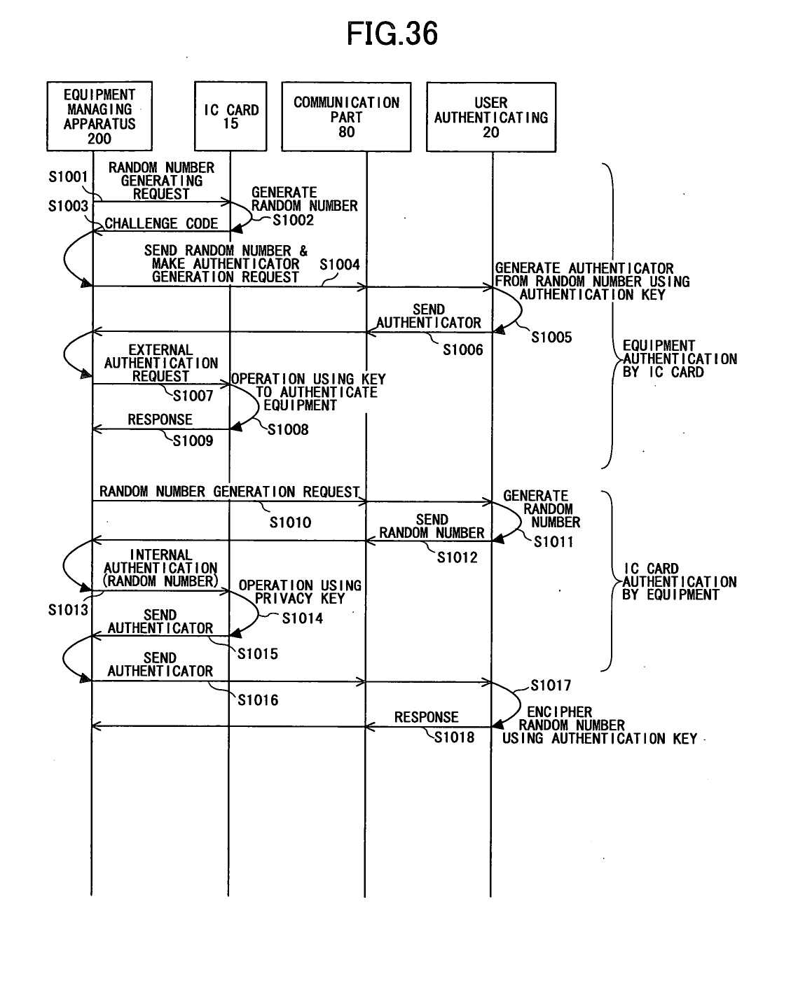

FIG. 36 is a flow chart for explaining an embodiment of a mutual authentication procedure between equipments. For the sake of convenience, it is assumed that the IC card 15 is used. However, the process may be carried out similarly using the IC card 25.

In FIG. 36, the equipment managing apparatus 200 makes a random number generation request with respect to the IC card 15 in a step S1001, and the IC card 15 generates a random number in a step S1002 and supplies the generated random number to the equipment managing apparatus 200, as a challenge code, in a step S1003. The equipment managing apparatus 200 supplies the random number to the user authenticating apparatus 20, together with an authenticator generation request, in a step S1004. The user authenticating part 20 generates an authenticator from the random number using an authentication key which is registered in advance in the equipment 100, in a step S1005. The user authenticating part 20 supplies the generated authenticator to the equipment managing apparatus 200 in a step S1006. The equipment managing apparatus 200 supplies the authenticator to the IC card 15, together with an external authentication request, in a step S1007. The IC card 15 carries out an operation with respect to the random number which is generated by the step S1002, using an authentication key for authenticating the equipment 100, so as to decide whether an operation result matches the authenticator received from the equipment managing apparatus 200, in a step S1008. It is judged that the external authentication was successful if the operation result matches authenticator, and that the external authentication failed if the operation result does not match the authenticator. The IC card 15 supplies a response indicating the authentication result to the equipment managing apparatus 200, in a step S1009. The process ends if the response indicates that the external authentication failed.

On the other hand, if the response indicates that the external authentication was successful, the equipment managing apparatus 200 makes a random number generation request with respect to the user authenticating part 20, in a step S1010. The user authenticating part 20 generates a random number in a step S1011, and supplies the random number to the equipment managing apparatus 200 in a step S1012. The equipment managing apparatus 200 supplies the random number to the IC card 15, together with an internal authentication request, in a step S1013. The IC card 15 carries out an operation with respect to the random number using the authentication key for authenticating the equipment 100, to generate an authenticator in a step S1014, and supplies the generated authenticator to the equipment managing apparatus 200 in a step S1015. The equipment managing apparatus 200 supplies the authenticator to the user authenticating part 20 in a step S1016. The user authenticating part 20 carries out an operation with respect to the random number which is generated by the step S1011, using the authentication key for authenticating the equipment, so as to decide whether an operation result matches the authenticator, in a step S1017. It is judged that the internal authentication was successful if the operation result matches the authenticator, and that the internal authentication failed if the operation result does not match the authenticator. The user authenticating part 20 supplies a response indicating the authentication result to the equipment managing apparatus 200, in a step S1018. The process ends if the response indicates that the internal authentication failed.

The steps S1001 through S1009 carry out the authentication (external authentication) of the equipment 100 by the IC card 15. The steps S1010 through S1018 carry out the authentication (internal authentication) of the IC card 15 by the equipment 100. Hence, the mutual authentication between the equipments can be made by the external authentication and the internal authentication.

5.2: Mutual Authentication Between Equipments

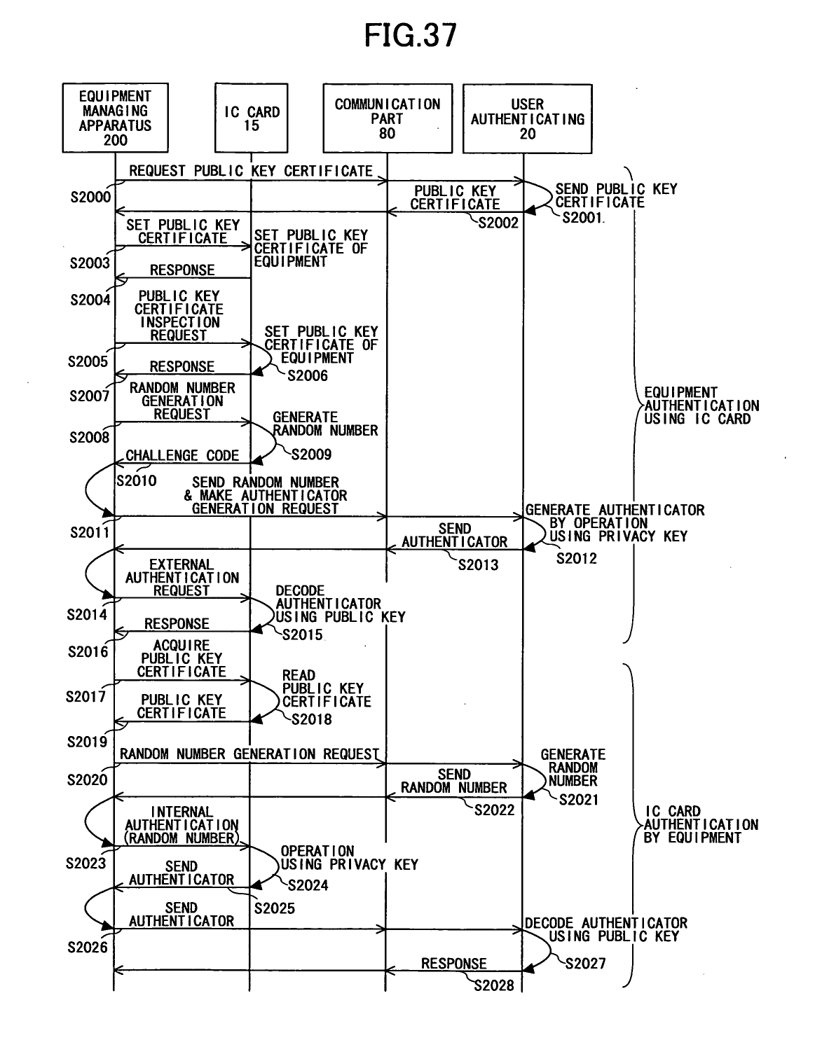

FIG. 37 is a flow chart for explaining another embodiment of the mutual authentication procedure between equipments. For the sake of convenience, it is assumed that the IC card 15 is used. However, the process may be carried out similarly using the IC card 25.

In FIG. 37, the equipment managing apparatus 200 makes a public key certificate request with respect to the equipment 100, in a step S2000. The user authenticating part 20 issues a public key certificate in a step S2001, and supplies the public key certificate to the equipment managing apparatus 200 in a step S2002. The equipment managing apparatus 200 sets the public key certificate with respect to the IC card 15 in a step S2003. The IC card 15 sets the public key certificate therein and supplies a response indicating whether or not the setting of the public key certificate was successful to the equipment managing apparatus 200, in a step S2004. The process ends if the response indicates that the setting of the public key certificate failed.

On the other hand, if the response indicates that the setting of the public key certificate was successful, the equipment managing apparatus 200 makes a public key certificate inspection request with respect to the IC card 15, in a step S2005. The IC card 15 inspects the public key certificate of the equipment 100 in a step S2006, and supplies a response indicating whether or not the inspection was successful to the equipment managing apparatus 200, in a step S2007. The process ends if the response indicates that the inspection of the public key certificate failed. If the response indicates that the inspection of the public key certificate was successful, the equipment managing apparatus 200 makes a random number generation request with respect to the IC card 15 in a step S2008. The IC card 15 generates a random number in a step S2009, and supplies the generated random number to the equipment managing apparatus 200, as a challenge code, in a step S2010.

The equipment managing apparatus 200 supplies the random number to the user authenticating part 20, together with an authenticator generation request, in a step S2011. The user authenticating part 20 generates an authenticator from the random number using a privacy key which is registered in advance in the equipment 100, in a step S2012. In addition, the user authenticating part 20 supplies the generated authenticator to the equipment managing apparatus 200 in a step S2013. The equipment managing apparatus 200 supplies the authenticator to the IC card 15, together with an external authentication request, in a step S2014. The IC card 15 carries out an operation with respect to the random number which is generated by the step S2009, using an authentication key for authenticating the equipment 100, and decides whether or not an operation result matches the authenticator, in a step S2015. It is judged that the external authentication was successful if the operation result and the authenticator match, and that the external authentication failed if the operation result and the authenticator do not match. The IC card 15 supplies a response indicating the authentication result to the equipment managing apparatus 200 in a step S2016. The process ends if the response indicates that the external authentication failed.

On the other hand, if the response indicates that the external authentication was successful, the equipment managing apparatus 200 makes a public key certificate request with respect to the IC card 15 in a step S2017. The IC card 15 reads the public key certificate which is set by the step S2003, in a step S2018, and supplies the read public key certificate to the equipment managing apparatus 200, in a step S2019. If the public key certificate is inspected and the inspection result indicates that the public key certificate is invalid due to expired valid term or the like, it is judged that the internal authentication failed, and the process ends.

If inspection result indicates that the public key certificate is valid, the equipment managing apparatus 200 makes a random number generation request with respect to the user authenticating part 20 in a step S2020. The user authenticating part 20 generates a random number in a step S2021, and supplies the generated random number to the equipment managing apparatus 200 in a step S2022. The equipment managing apparatus 200 supplies the random number to the IC card 15, together with an internal authentication request, in a step S2023. The IC card 15 carries out an operation with respect to the random number using a privacy key to generate an authenticator in a step S2024, and supplies the generated authenticator to the equipment managing apparatus 200 in a step S2025. The equipment managing apparatus 200 supplies the authenticator to the user authenticating part 20 in a step S2026. The user authenticating part 20 carries out an operation with respect to the random number which is generated by the step S2021, using the authentication key for authenticating the equipment 100, and decides whether or not an operation result matches the authenticator, in a step S2027. It is judged that the internal authentication was successful if the operation result and the authenticator match, and that the internal authentication failed if the operation result and the authenticator do not match. The user authenticating part 20 supplies a response indicating the authentication result to the equipment managing apparatus 200 in a step S2028. The process ends if the response indicates that the internal authentication failed.

The steps S2000 through S2016 carry out the authentication (external authentication) of the equipment 100 by the IC card 15. The steps S2017 through S2028 carry out the authentication (internal authentication) of the IC card 15 by the equipment 100. Hence, the mutual authentication between the equipments can be made by the external authentication and the internal authentication.

In each of the embodiments described above, various kinds of authenticating media may be used in place of the IC cards 15 and 25. It is desirable that the authenticating media such as the IC cards 15 and 25 are provided with a memory to which various data can be written and from which the various data can be read, and a processor such as a CPU which can carry out a data processing. However, in the case of an authenticating medium which is not provided with a processor, a processor within a reader and writer to which the authenticating medium is inserted or, a processor within an apparatus having therein the reader and writer, may be used to carry out various data processing.

The electronic equipment according to the present invention corresponds to the maintenance target equipment of the described embodiments. The equipment managing apparatus according to the present invention corresponds to the equipment managing apparatus (or equipment maintenance apparatus) or the operating terminal at the equipment setup site. The equipment maintenance system according to the present invention is formed by the equipment managing apparatus of the maintenance service provider or, the equipment managing apparatus and the maintenance permit issuing apparatus of the maintenance service provider or, the operating terminal at the equipment setup site or, the operating terminal and the maintenance permit issuing apparatus at the equipment setup site or, a combination of the apparatus of the maintenance service provider and the apparatus at the equipment setup site. The equipment maintenance method according to the present invention is employed in such an equipment maintenance system. The computer-readable storage medium according to the present invention stores a program which causes a computer forming the apparatus within the equipment managing system to variably set the maintenance range and/or the management range of the maintenance target equipment. The computer-readable storage medium may be formed by any kind of recording medium capable of storing the program in a computer-readable manner. For example, recording media such as magnetic recording media, optical recording media, magneto-optical recording media and semiconductor memory devices may form the computer-readable storage medium.

Further, the present invention is not limited to these embodiments, but various variations and modifications may be made without departing from the scope of the present invention.

What is claimed is:

1. An electronic equipment having parts which may be subjected to maintenance and are specified by a maintenance range, comprising:
a setting part which is set with a predetermined maintenance range in which the maintenance is permitted;
an authenticating part to authenticate validity of a maintenance-attending person for the electronic equipment; and
a changing part to temporarily change the predetermined maintenance range set in said setting part, in response to a change instruction, when said authenticating part authenticates the validity of the maintenance-attending person.

2. The electronic equipment as claimed in claim 1, wherein said setting part is preset wit a maintenance range for each maintenance person.

3. The electronic equipment as claimed in claim 1, wherein said authenticating part authenticates the validity of the maintenance-attending person using an authenticating medium which stores authentication information of the maintenance-attending person.

4. The electronic equipment as claimed in claim 1, wherein said changing part adds a maintenance range specified by the change instruction only for a period of time specified by the change instruction, with respect to the predetermined maintenance range.

5. The electronic equipment as claimed in claim 1, wherein said setting part is also set with a predetermined management range in which management is permitted, and said changing part also temporarily changes the predetermined management range set in said setting part, in response to the change instruction, when said authenticating part authenticates the validity of the maintenance-attending person.

6. The electronic equipment as claimed in claim 1, further comprising:
an input part to permit input of the change instruction by an operator whose validity is authenticated.

7. An equipment managing apparatus for controlling an electronic equipment which includes a setting part which is set with a predetermined maintenance range in which maintenance is permitted, a first authenticating part to authenticate validity of a maintenance-attending person for the electronic equipment, and a changing part to temporarily change the predetermined maintenance range set in the setting part in response to a change instruction when the first authenticating part authenticates the validity of the maintenance-attending person, said equipment managing apparatus comprising:
a second authenticating part to authenticate validity of an operator of the equipment managing apparatus;
an input part to permit input of the change instruction when the second authenticating part authenticates the validity of the operator; and
a part to supply the change instruction input from said input part to the electronic equipment.

8. The equipment managing apparatus as claimed in claim 7, wherein said second authenticating part authenticates the validity of the operator using an authenticating medium which stores authentication information of the operator.

9. An equipment maintenance system for controlling a maintenance range in which maintenance of an equipment may be performed, comprising:
a setting part to set in advance a maintenance range in which the maintenance of the equipment is permitted;
a first authenticating part to authenticate validity of a maintenance-attending person for the equipment; and
a changing part to temporarily change the set maintenance range to a predetermined maintenance range based on an authentication result of said first authenticating part, so that the maintenance of the equipment is temporarily permitted within the predetermined maintenance range.

10. The equipment maintenance system as claimed in claim 9, wherein said setting part is provided within a maintenance service provider which provides maintenance services for the equipment or, within a setup site of the equipment.

11. The equipment maintenance system as claimed in claim 9, wherein said changing part is provided within a maintenance service provider which provides maintenance services for the equipment or, within a setup site of the equipment.

12. The equipment maintenance system as claimed in claim 11, wherein said changing part is provided in an apparatus within the maintenance service provider, and said apparatus is communicatable with the equipment via a network.

13. The equipment maintenance system as claimed in claim 11, wherein said changing part is provided in an apparatus within the maintenance service provider or, provided within the equipment, and said apparatus is communicatable with the equipment via a network.

14. The equipment maintenance system as claimed in claim 9, further comprising:
a second authenticating part to authenticate validity of an operator of said changing part.

15. The equipment maintenance system as claimed in claim 14, wherein said second authenticating part authenticates the validity of the operator using an authenticating medium which stores authentication information of the operator.

16. The equipment maintenance system as claimed in claim 9, wherein said first authenticating part authenticates the validity of the maintenance-attending person using an authenticating medium which stores authentication information of a maintenance person.

17. The equipment maintenance system as claimed in claim 9, wherein said setting part sets in advance a maintenance range for each maintenance person.

18. The equipment maintenance system as claimed in claim 9, further comprising:
a maintenance part to perform maintenance of the equipment within the predetermined maintenance range.

19. The equipment maintenance system as claimed in claim 18, wherein said maintenance part is provided in an apparatus within a maintenance service provider which provides maintenance services for the equipment, and said apparatus is communicatable with the equipment via a network to perform remote maintenance of the equipment.

20. The equipment maintenance system as claimed in claim 18, wherein said maintenance part is provided within an apparatus in a setup site of the equipment or, within the equipment, and said apparatus is communicatable with the equipment via a network.

21. The equipment maintenance system as claimed in claim 9, wherein the equipment is selected from a group consisting of information processing apparatus, office automation (OA) equipment, point-of sales (POS) terminal equipment, medical equipment, vending machine, electrical home appliance, and portable terminal equipment.

22. An equipment maintenance method for controlling a maintenance range in which maintenance of an equipment may be performed, comprising the steps of:
(a) setting in advance a maintenance range in which the maintenance of the equipment is permitted;
(b) authenticating validity of a maintenance-attending person for the equipment; and
(c) temporarily changing the set maintenance range to a predetermined maintenance range based on an authentication result of said step (b), so that the maintenance of the equipment is temporarily permitted within the predetermined maintenance range.

23. The equipment maintenance method as claimed in claim 22, wherein said step (a) is performed within a maintenance service provider which provides maintenance services for the equipment or, within a setup site of the equipment.

24. The equipment managing method as claimed in claim 22, wherein said step (c) is carried out within a maintenance service provider which provides maintenance services for the equipment or, within a setup site of the equipment.

25. The equipment managing method as claimed in claim 24, wherein said step (c) is carried out in an apparatus within the maintenance service provider, and said apparatus is communicatable with the equipment via a network.

26. The equipment maintenance method as claimed in claim 24, wherein said step (c) is carried out in an apparatus within the maintenance service provider or, provided within the equipment, and said apparatus is communicatable with the equipment via a network.

27. The equipment maintenance method as claimed in claim 22, further comprising the steps of:
(d) authenticating validity of an operator of said changing part.

28. The equipment maintenance method as claimed in claim 27, wherein said step (d) authenticates the validity of the operator using an authenticating medium which stores authentication information of the operator.

29. The equipment maintenance method as claimed in claim 22, wherein said step (b) authenticates the validity of the maintenance-attending person using an authenticating medium which stores authentication information of a maintenance person.

30. The equipment maintenance method as claimed in claim 22, wherein said step (a) sets in advance a maintenance range for each maintenance person.

31. The equipment maintenance method as claimed in claim 22, further comprising the steps of:
(e) carrying out maintenance of the equipment within the predetermined maintenance range.

32. The equipment maintenance method as claimed in claim 31, wherein said step (e) is carried out in an apparatus within a maintenance service provider which provides maintenance services for the equipment, and said apparatus is communicatable with the equipment via a network to perform remote maintenance of the equipment.

33. The equipment maintenance method as claimed in claim 31, wherein said step (e) is carried out within an apparatus in a setup site of the equipment or, within the equipment, and said apparatus is communicatable with the equipment via a network.

34. The equipment maintenance method as claimed in claim 22, wherein the equipment is selected from a group consisting of information processing apparatus, office automation (OA) equipment, point-of sales (POS) terminal equipment, medical equipment, vending machine, electrical home appliance, and portable terminal equipment.

35. An electronic equipment having parts which may be subjected to maintenance and are specified by a maintenance range, comprising:
setting means set with a predetermined maintenance range in which the maintenance is permitted;
authenticating means for authenticating validity of a maintenance-attending person for the electronic equipment; and
changing means for temporarily changing the predetermined maintenance range set in said setting means, in response to a change instruction, when said authenticating means authenticates the validity of the maintenance-attending person.

36. An equipment managing apparatus for controlling an electronic equipment which includes setting means set with a predetermined maintenance range in which maintenance is permitted, first authenticating means for authenticating validity of a maintenance-attending person for the electronic equipment, and changing means for temporarily changing the predetermined maintenance range set in the setting part in response to a change instruction when the first authenticating means authenticates the validity of the maintenance-attending person, said equipment managing apparatus comprising:
second authenticating means for authenticating validity of an operator of the equipment managing apparatus;
input means for permitting input of the change instruction when the second authenticating means authenticates the validity of the operator; and
means for supplying the change instruction input from said input means to the electronic equipment.

37. An equipment maintenance system for controlling a maintenance range in which maintenance of an equipment may be performed, comprising:
setting means for setting in advance a maintenance range in which the maintenance of the equipment is permitted;
authenticating means for authenticating validity of a maintenance-attending person for the equipment; and
changing means for temporarily changing the set maintenance range to a predetermined maintenance range based on an authentication result of said authenticating means, so that the maintenance of the equipment is temporarily permitted within the predetermined maintenance range.

38. A computer-readable storage medium which stores a program for causing a computer to set a maintenance range which specifies parts of an electronic equipment which may be subjected to maintenance, said program comprising:
a setting procedure causing the computer to be set with a predetermined maintenance range in which the maintenance is permitted;
an authenticating procedure causing the computer to authenticate validity of a maintenance-attending person for the electronic equipment; and
a changing procedure causing the computer to temporarily change the predetermined maintenance range set in said setting procedure, in response to a change instruction, when said authenticating procedure authenticates the validity of the maintenance-attending person.

39. A computer-readable storage medium which stores a program for causing a computer to manage an electronic equipment which includes a setting part set with a predetermined maintenance range in which maintenance is permitted, an authenticating part to authenticate validity of a maintenance-attending person for the electronic equipment, and a changing part to temporarily change the predetermined maintenance range set in the setting part in response to a change instruction when the authenticating part authenticates the validity of the maintenance-attending person, said program comprising:
an authenticating procedure causing the computer to authenticate validity of an operator of the computer;
an input procedure causing the computer to permit input of the change instruction when the authenticating procedure authenticates the validity of the operator; and
a procedure causing the computer to supply the change instruction input by said input procedure to the electronic equipment.

40. A computer-readable storage medium which stores a program for causing a computer to control a maintenance range in which maintenance of an equipment may be performed, said program comprising:
a setting procedure causing the computer to set in advance a maintenance range in which the maintenance of the equipment is permitted;
an authenticating procedure causing the computer to authenticate validity of a maintenance-attending person for the equipment; and
a changing procedure causing the computer to temporarily change the set maintenance range to a predetermined maintenance range based on an authentication result of said authenticating procedure, so that the maintenance of the equipment is temporarily permitted within the predetermined maintenance range.
